(19) United States
(12) Patent Application Publication
(10) Pub. No.: US 2018/0047074 A1
(43) Pub. Date: Feb. 15, 2018

(54) WEARABLE DEVICES AS A SERVICE

(71) Applicant: KONINKLIJKE PHILIPS N.V., EINDHOVEN (NL)

(72) Inventors: John Cronin, Bonita Springs, FL (US); John Ames, Andover, MA (US); Kyle Trout, Cambridge, MA (US)

(21) Appl. No.: 15/549,696

(22) PCT Filed: Feb. 8, 2016
(86) PCT No.: PCT/EP2016/052593

§ 371 Date: Aug. 9, 2017

Related U.S. Application Data
(60) Provisional application No. 62/113,999, filed on Feb. 9, 2015.

(51) Int. Cl. G06Q 30/04; H04L 29/06; G06F 1/16

(52) U.S. Cl. CPC G06Q 30/04; G06F 1/163; H04L 63/08

(57) ABSTRACT

Various embodiments described herein relate to a service broker framework or device and associated methods and non-transitory machine-readable storage media including a communications interface; a memory storing: a user profile associated with a user and specifying an input type available from a sensor device of the user, wherein the input type is a physiological parameter of the user, and service records associated with respective services and identifying respective input types and servers that provide the services; and a processor configured to: receive, from the user via the communications interface, a request to add a service identified by a service record indicates that the input type specified by the user profile is accepted by the service as an input, effect transmission of data gathered by the sensor device of the user and of the input type identified by the service record to a server identified by the service record.

### CROSS-REFERENCE TO RELATED APPLICATIONS

The present application claims the priority benefit of U.S. provisional application No. 62/113,999 filed Feb. 9, 2015 and entitled “Wearables as a service,” the entire disclosure of which is hereby incorporated herein by reference for all purposes.

### TECHNICAL FIELD

Various embodiments described herein relate to wearable devices and more particularly, but not exclusively, to a framework for expanding the functionality of wearable devices through added services.

### BACKGROUND

Wearable technology may include any type of mobile electronic device that can be worn on the body, attached to, or embedded in clothes and accessories of an individual and currently exists in the consumer and medical marketplaces. Processors and sensors associated with the wearable technology can display, process, gather, or elicit information. Such wearable technology may be used in a variety of areas, including monitoring health data of the user as well as other types of data and statistics. These types of devices may be readily available to the public and may be easily purchased by consumers. Examples of some wearable technology in the health arena include FIT BIT, NIKE+ FUEL BAND, and APPLE WATCH devices.

### SUMMARY

Various embodiments described herein relate to a service broker device comprising: a communications interface; a memory storing: a user profile associated with a user and specifying an available input type available from a sensor device of the user, wherein the input type is a physiological parameter of the user, and a plurality of service records, wherein a first service record of the plurality of service records is associated with a service, an input type, and a server that provides the service; and a processor in communication with the communications interface and the memory, the processor being configured to: receive, from the user via the communications interface, a request to add, for the user, the service associated with the first service record of the plurality of service records, wherein the service record indicates that the available input type specified by the user profile is accepted by the server as an input for providing the service, effect transmission of data gathered by the sensor device of the user and of the input type identified by the service record to the server associated with the service record.

Various embodiments described herein relate to a method performed by a processor of a service broker device for expanding services provided via wearable devices, the method including: receiving, from a user, an identification of an available input type available from a sensor device of the user, wherein the input type is a physiological parameter of the user; receiving, from the user, a request to add a service, wherein the service is known to accept the available input type as an input; and effecting transmission of data gathered by the sensor device of the user and of the available input type to a server that provides the service.

Various embodiments described herein relate to a non-transitory machine-readable storage medium encoded with instructions for execution by a processor of a service broker device for expanding services provided via wearable devices, the non-transitory machine-readable storage medium including: instructions for receiving, from a user, an identification of an available input type available from a sensor device of the user, wherein the input type is a physiological parameter of the user; instructions for receiving, from the user, a request to add a service, wherein the service is known to accept the available input type as an input; and instructions for effecting transmission of data gathered by the sensor device of the user and of the available input type to a server that provides the service.

Various embodiments are described wherein, in effecting transmission of data gathered by the sensor device of the user and of the input type identified by the service record to the server identified by the service record, the processor is configured to: transmit configuration information to an input device, wherein the input device is at least one of the sensor device of the user and a reporting framework device that receives the data from the sensor device; wherein the configuration information configures the input device to transmit the data directly to the server identified by the service record.

Various embodiments are described wherein, in effecting transmission of data gathered by the sensor device of the user and of the input type identified by the service record to the server identified by the service record, the processor is configured to: transmit credentials information to the server identified by the service record, wherein the credentials information enables the server to request the data from at least one of the sensor device of the user and a reporting framework device associated with the sensor device.

Various embodiments are described wherein, in effecting transmission of data gathered by the sensor device of the user and of the input type identified by the service record to the server identified by the service record, the processor is configured to: record an indication in association with the user that the data is to be forwarded to the server identified by the service record; receive the data from at least one of the sensor device of the user and a reporting framework device associated with the sensor device; based on the recorded indication, transmit the received data to the server.

Various embodiments are described wherein: the service record identifies an input processing action to be performed prior to transmission; and the processor is further configured to, prior to transmitting the received data to the server, modify the data according to the input processing action.

Various embodiments are described wherein: the service record is associated with an output type of the service, wherein the output type is another physiological parameter; and the processor is further configured to add the service to the user profile as an additional sensor device that provides an additional input type, wherein the additional input type is the output type identified by the service record.

Various embodiments are described wherein the processor is further configured to effect billing of at least one of the user and a provider of the service in response to the request to add the service.

Various embodiments are described wherein the processor is further configured to: identify a set of available services for the user based on the respective input types of the available services being available from the user as indicated by the user profile; and present the set of available services to the user for selection of individual services to add for the user.

Various embodiments are described wherein the processor is further configured to: receive a selection of a first additional service from the user, wherein the first additional service is associated with an additional service record of the plurality of service records; determine that an additional input type identified by the additional service record is not identified as available from the user based on the user profile; and presenting at least one offering to the user that would provide the additional input type.

Various embodiments are described wherein the offering includes a second additional service that provides the additional input type as an output.

### BRIEF DESCRIPTION OF THE DRAWINGS

In order to better understand various example embodiments, reference is made to the accompanying drawings, wherein:

FIG. 1 illustrates an example of a system for providing wearables as a service;

FIG. 2 illustrates an example of hardware for implementing various devices that participate in the various systems described herein;

FIG. 3 illustrates an example service broker framework;

FIG. 4 illustrates an example of an environment for providing wearables as a service;

FIG. 5 illustrates an example of an interface for defining a new service;

FIG. 6 illustrates an example of an interface for defining new offering;

FIG. 7 illustrates an example of a data arrangement for defining a user profile;

FIG. 8 illustrates an example of a method for enrolling a sensor device for a user;

FIG. 9 illustrates an example interface for browsing offerings;

FIG. 10 illustrates an example of a method for generating offering recommendations;

FIG. 11 illustrates an example of a method for training a predictive model;

FIG. 12 illustrates an example of a method for displaying service details;

FIG. 13 illustrates an example of an interface for adding a new service for a user;

FIG. 14 illustrates an example of a method for effecting an offering purchase;

FIG. 15 illustrates an example of a method for facilitating input sharing; and

FIG. 16 illustrates an example of a method for facilitating output presentation.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

While many different wearable devices having diverse sets of sensors are available, the use to which these sensors are put are typically tied to the device manufacturer. For example, the device may be shipped with a preloaded algorithm for interpreting sensor data (e.g., converting raw accelerometer data into a number of steps taken) that is not capable of later improvement, expansion, or other updating. As another example, a wearable device may report parameters (both raw parameters from the sensors and computer parameters generated by on-board algorithms) to a server of the manufacturer which then provides additional processing, organization, presentation, and other services. These remote services, however, are still tied to what the manufacturer is able to develop, host, and otherwise provide.

To address these and other aspects of wearable devices, various embodiments described herein relate to a framework for providing new services to wearable device users outside of the rigid framework set up by various wearable device manufacturers. According to some embodiments, a service broker framework allows a user to register sensors available to them provided by the wearable devices (and other devices), shop for services offered by third parties, and facilitate the communication between added services and the sensors upon which their operation depends.

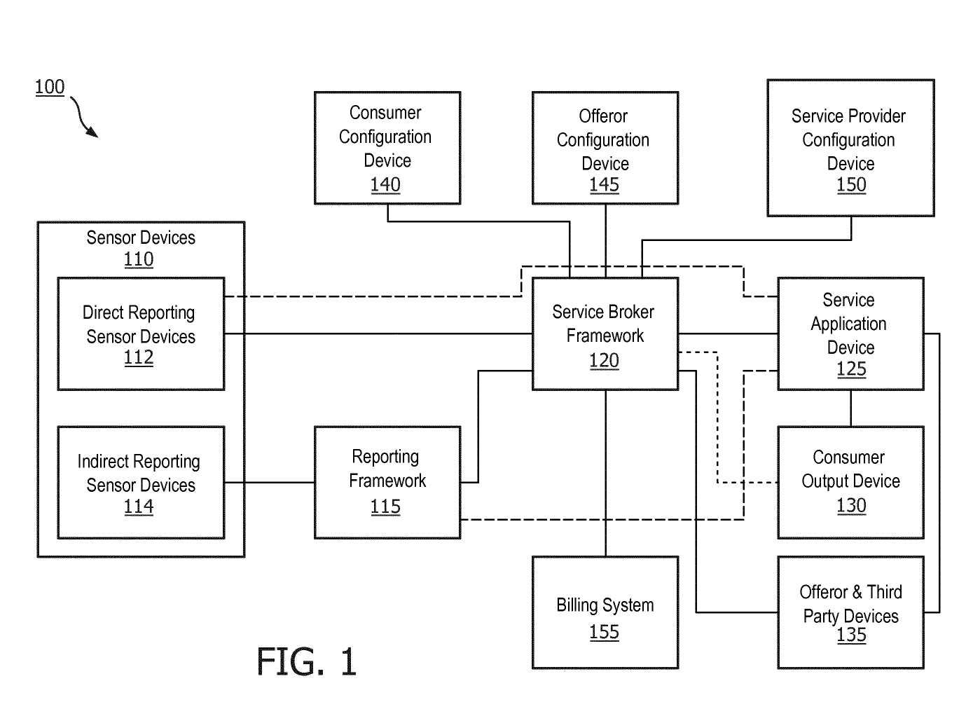

FIG. 1 illustrates an example of a system 100 for providing wearables as a service. The system 100 shown illustrates various functional components and some interactions therebetween. It will be appreciated that such functional components will be implemented using physical hardware and, in some embodiments, software executed by the hardware. Thus, each functional device or engine may be embodied in a dedicated hardware device. Additionally, in some embodiments, two or more of the functional devices of the system 100 may be embodied in a single hardware device. For example, in some embodiments, some sensor devices 110, consumer output device 130, and consumer configuration device 140 may be embodied in a single device such as, for example, a mobile device, tablet, or wearable device having sufficient user interface capabilities.

While the system 100 shows some functional devices as being single devices and others as including multiple similar devices, it will be understood that alternative arrangements are possible. For example, an alternative system may use only a single sensor device 110 but may include multiple redundant service broker frameworks 120 (e.g., with a load balancer, not shown, to distribute requests, user data, or other actionable information evenly therebetween to enable service broker framework 120 to serve a large number of wearers and sensor devices 110).

The sensor devices 110 may be virtually any sensor capable of sensing data about a user, the user's environment, the user's context, the state of various electronics associated with the user, etc. In some embodiments, the sensor devices 110 may sense physiological parameters about the user. For example, the sensor devices 110 may include accelerometers, conductance sensors, optical sensors, temperature sensors, microphones, cameras, etc. These or other sensors may be useful for sensing, computing, estimating, or otherwise acquiring physiological parameters descriptive of the wearer such as, for example, steps taken, walking/running distance, standing hours, heart rate, respiratory rate, blood pressure, stress level, body temperature, calories burned, resting energy expenditure, active energy expenditure, height, weight, sleep metrics, etc.

While many useful parameters may be obtained directly from sensor devices 110, other useful parameters are obtained by “extracting” them from other available data (including the sensor data). For example, raw accelerometer data may be processed to extract a number of steps taken, an estimate of calories burned, or an estimate of an activity being performed by the user (e.g., running, playing tennis, biking, etc.) Accordingly, various devices in the system may implement parameter extraction algorithms for processing available parameters (e.g., sensed parameters and other extracted parameters) to generate new parameters. In some embodiments, the sensor devices 110 may implement such algorithms for parameter extraction in the same device as at least some of the sensors that obtain parameters upon which the algorithms depend or for parameter extraction that is local to the user though not necessarily in the same device as the predicate sensors. For example, in some embodiments, a wearable bracelet may report accelerometer data to a user's mobile device, which then applies an algorithm to estimate a number of steps taken using the accelerometer data. Additionally or alternatively, virtually any device may apply such parameter extraction algorithms (which. In some cases, may be provided as a service according to the systems and methods described herein). For example, the reporting framework 115, service broker framework 120, service application device 125, consumer output device 130, or some other device (pictured or not pictured) may perform parameter extraction from input parameters available to the device. To the extent that such other devices may extract parameters that may be used as input to other services, such other devices may be considered sensor devices 110 themselves. For example, a service application device 125 that processes accelerometer data to estimate calories burned may also be considered a sensor device 110 that provides a calorie estimation for other services.

According to various embodiments described herein, sensor devices 110 may be divided among two groups: direct reporting sensor devices 112 and indirect reporting sensor devices 114. Direct reporting sensor devices 112 may include any sensor device 110 that can be configured (e.g., by the service broker framework) to transmit parameters to other devices (e.g., the service broker framework 120 or service application device 125). Such configuration may include adding a domain name or IP address to a configuration file of the direct reporting sensor device 112 to indicate a network location to which parameters should be transmitted. As an alternative, another device (e.g., the service broker framework 120) may periodically request that such parameters be reported. Various authentication and authorization may also be performed such as, for example, configuring the direct reporting sensor device 112 with information for confirming an identity (e.g., a password or public key) of the device to which parameters will be transmitted. In some embodiments, such configuration may require the user's manual approval.

Indirect reporting sensor devices 114, on the other hand, may not be configurable in such a manner and, instead, may only report parameters to predefined entities such as, for example, proprietary servers of the sensor device 110 manufacturer or a framework such as the AWS Internet of Things (IoT) cloud platform. Collectively, these other entities may be considered to constitute reporting frameworks 115. The reporting framework 115 may provide an application programmer's interface (API) for allowing access to the parameters reported by the indirect reporting sensor devices 114 (and, in some embodiments, parameters extracted by the reporting framework 115 itself). Similar authentication and authorization measures may be taken with respect to the reporting framework 115 and indirect reporting sensor devices 114 as described above with respect to the direct reporting sensor devices. For example, the service broker framework 120 may indicate to the reporting framework 115 (via the API) an identification of the parameters which should be provided to the service broker framework 120 along with a token indicating the user's approval for such sharing (or useful in obtaining such approval). Thereafter, the reporting framework 115 may periodically or upon request transmit such parameters to the service broker framework 120 (or other device such as a service application device 125).

The service broker framework 120 may be one or more devices that performs various functions for facilitating wearables as a service. According to various embodiments, the service broker framework provides a “marketplace” for users to browse and subscribe to services offered via the service broker framework. As such, a service provider configuration device 150 (e.g., a personal computer, server, VM, etc.) may communicate with the service broker framework 120 (e.g., via a web page or API) to define services to be facilitated the service broker framework 120 marketplace; an offeror configuration device 145 (e.g., a personal computer, server, VM, etc.) may communicate with the service broker framework 120 (e.g., via a web page or API) to define one or more offerings (e.g., of services, hardware, packages of services or hardware, etc.) to be offered through the service broker framework 120 to consumers; and a consumer configuration device 140 (e.g., a mobile phone, tablet, personal computer, wearable device, etc.) may communicate with the service broker framework 120 (e.g., via a web page or API) to enroll a user's sensor devices 110, subscribe to services, purchase hardware, etc. In some embodiments, the service provider may, at the time of defining or configuring a service also offer that service for sale or subscription, potentially using a single interface or group of interfaces. In such embodiments, the service provider configuration device 150 may also be considered an offer configuration device 145.

In some embodiments, the service broker framework 120 may also facilitate the transmission of parameters between the various devices of the system 100. For example, in some embodiments, the service broker framework 120 may act as an intermediary by gathering or otherwise receiving input parameters for a service and forwarding them to a service application device 125 for processing according to a subscribed service for the user. In some such embodiments, the service broker framework 120 may perform some preprocessing (e.g., additional parameter extraction, formatting, translating, packaging of parameters, etc.) prior to forwarding the parameters to the service application device 125. In a similar manner, the service broker framework 120 may additionally facilitate the return of information output by the service application device 125 (again, potentially with preprocessing) to the consumer output device 130.

As another example, the service broker framework 120 may facilitate the transmission of parameters between devices by configuring one or more devices to establish communication therebetween without the service broker framework 120 acting as an intermediary. For example, the service broker framework 120 may provide an address of the service application device 125 to the relevant sensor devices 110 or reporting frameworks 115 such that these devices may thereafter transmit parameters to the service application device 125. Additionally or alternatively, the service broker framework 120 may provide the service application device 125 with the address of the relevant sensors 110 or reporting frameworks 115 for polling. In some embodiments, configurations of any of these devices may also include providing authorization information such as, for example, an authorization token (e.g., an API token) generated by the service broker framework 120 or other device for presentation upon transmission of parameters or a request for such a transmission.

The service broker framework 120 may also facilitate billing associated with purchases and subscriptions by submitting requests for payment to one or more billing systems 155. For example, where a consumer pays for a subscription to a service on a monthly basis, the service broker framework 120 may submit requests for payment against a payment instrument of the consumer each month. Additional arrangements and modifications will be apparent such as, for example, one-time payments upon purchase; payment, in whole or in part by a party other than the consumer (e.g., by an insurance company or physician as part of an incentive program); or payment to the consumer himself (e.g., as remuneration for agreement to share data or receive advertisements as separate services or in connection with another service).

In various embodiments, services facilitated by the service broker framework 120 may be hosted at an external service application device 125 operated, for example, by the service provider. The service application device 125 may be, for example, a server or VM configured to process input and provide some output (e.g., additional extracted parameters, coaching, etc.) according to a service offered to a consumer. In some embodiments, a service may be provided by installing one or more algorithms (e.g., parameter extraction algorithms) directly onto a device of the consumer (e.g. a sensor device 110 or other device); in such embodiments, the consumer's device may be considered a service application device 125 and may be the same device as the consumer output device 130. Thus, in some embodiments, the service broker framework 120 may act to facilitate transmission of parameters between multiple devices owned by the same consumer.

The consumer output device 130 may be virtually any device accessible to the consumer for receiving output from one or more services, either directly from the service application device 125 or via the service broker framework 120. For example, the consumer output device 130 may be a personal computer, mobile phone, tablet, or wearable device. In some embodiments, the consumer output device 130 may receive output from the service application device via a web browser (e.g., from a website hosted by the service application device) or an app or other program installed on the consumer output device provided by the service provider (e.g., a service front-end program that receives output pushed to it by the service application device 125 or service broker framework 120; or accesses output via an API offered by the service application device. Various additional channels for communication between the service application device 125 and consumer output device 130 will be apparent such as, for example, email, telephone calls, text messages, etc. In embodiments wherein the consumer output device 130 utilizes an app to access service output, the service broker framework 120 may, upon subscription to the service, link the consumer output device to (or otherwise provide an identification of) the app or a location where the app can be downloaded (e.g., a server operated by the service broker framework 120 or another app marketplace independent from the service broker).

According to various embodiments, various offerors and other third parties in addition to consumers and service providers may participate in the system. As such, offeror & third party devices 135 may additionally receive information from the service broker framework 120, service application device 125, or other devices such as parameters, demographics, usage data, and other information. For example, in some embodiments, a physician server 135 may receive information about patients that participate in the system as consumer; an advertisement server 135 may provide advertisements for display to a consumer and receive information about such display and clickthroughs; a third party data collector may receive parameters and other information if the user has assented to such collection (e.g., as part of an offering that pays the user or offers a discount on one or more services in exchange for such data collection); or a cloud services provider (e.g., cloud storage) may receive data for storage and later retrieval (or other services such as processing, etc.) by the service broker framework 120 or the service application device 125 (e.g., where a service requires such additional services but does not provide them on site or without separate procurement via the service broker framework 120 or otherwise by the consumer).

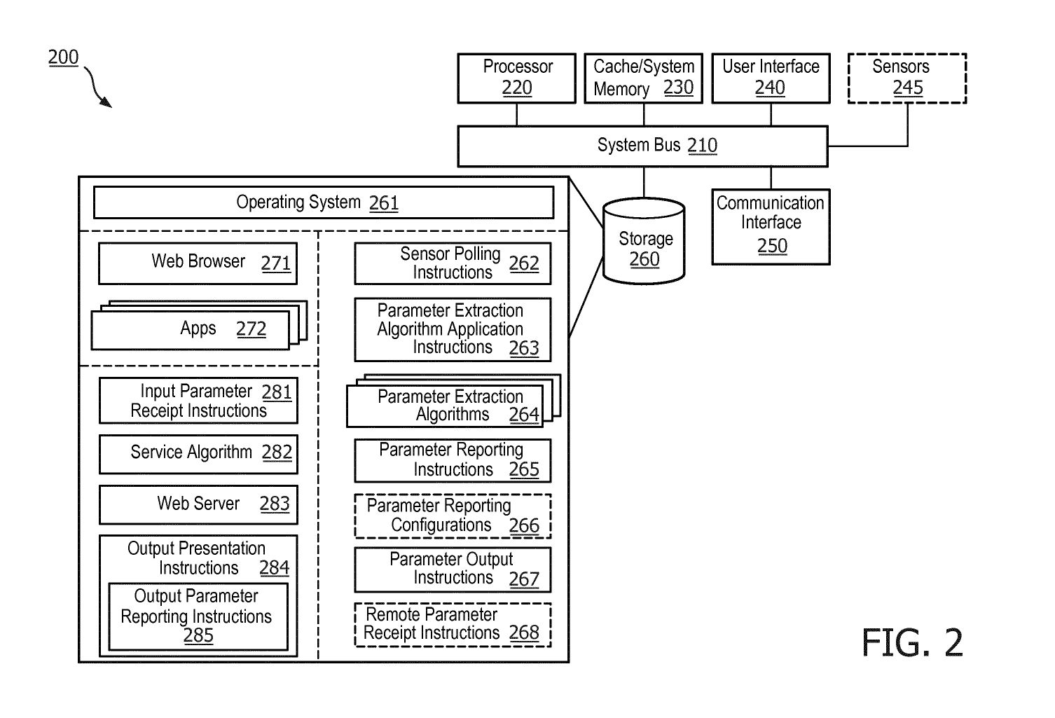

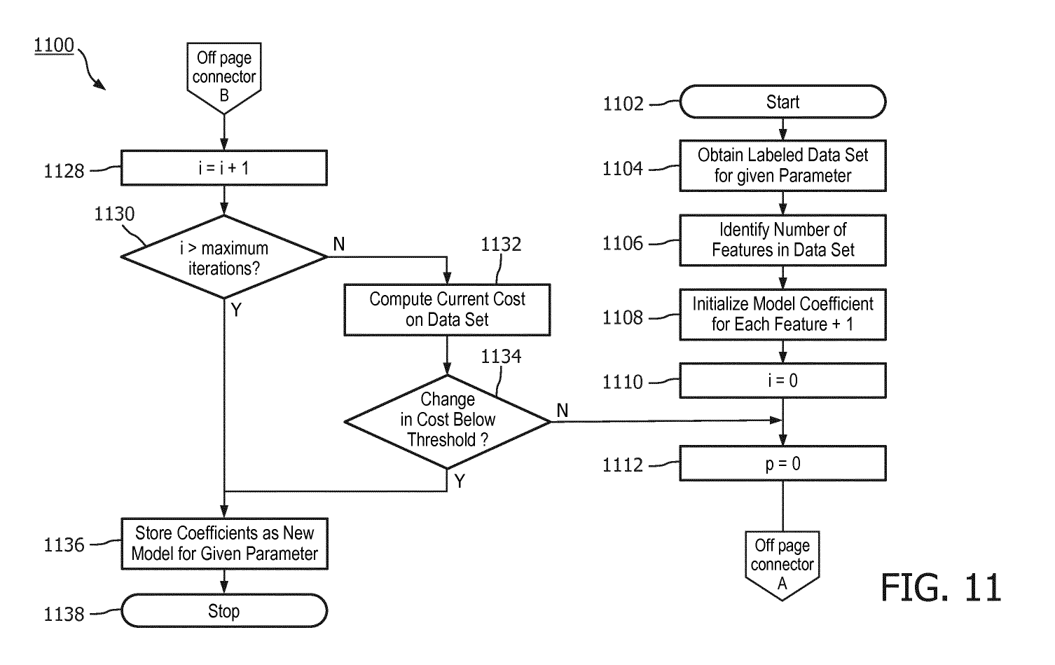

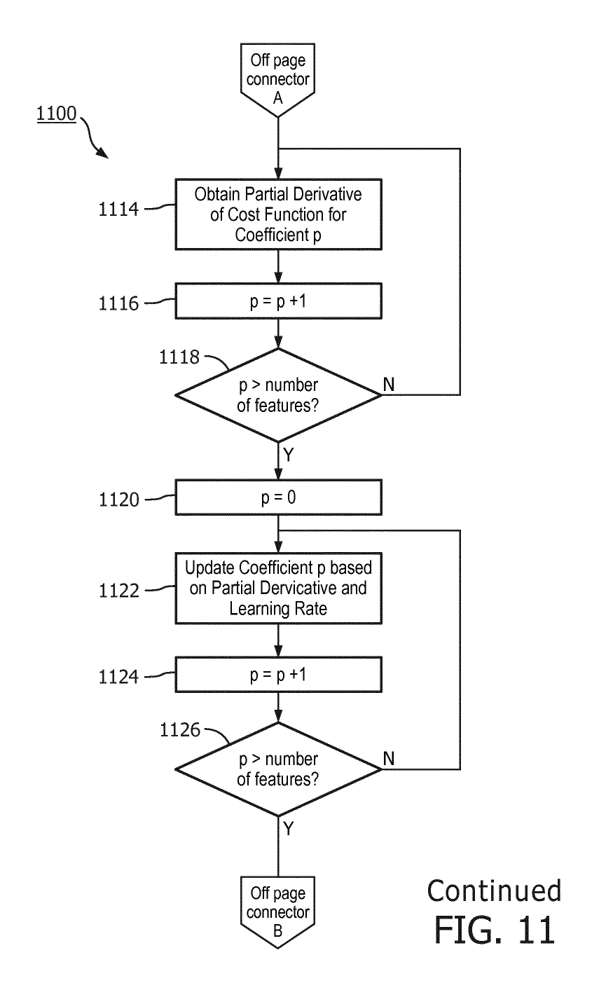

FIG. 2 illustrates an example of hardware 200 for implementing various devices that participate in the various systems described herein, such as the various functional devices of the system 100 of FIG. 1. For example, the hardware 200 may implement a sensor device 110, a service broker framework 120, a consumer configuration device 140, a consumer output device 130, a service application device 125, or any of the other devices described herein. As shown, the device 200 includes a processor 220, cache/system memory 230, user interface 240, network interface 250, and storage 260, and for some devices, sensors 245 interconnected via one or more system buses 210. It will be understood that FIG. 11 constitutes, in some respects, an abstraction and that the actual organization of the components of the device 200 may be more complex than illustrated.

The processor 220 may be any hardware device capable of executing instructions stored in memory 230 or storage 260 or otherwise processing data. As such, the processor may include a microprocessor, field programmable gate array (FPGA), application-specific integrated circuit (ASIC), or other similar devices. In some embodiments, such as those relying on one or more ASICs, the functionality described as being provided in part via software may instead be hardwired into the operation of the ASICs and, as such, the associated software may be omitted.

The cache/system memory 230 may include various memories such as, for example L1, L2, or L3 cache or system memory. As such, the memory 230 may include static random access memory (SRAM), dynamic RAM (DRAM), flash memory, read only memory (ROM), or other similar memory devices.

The user interface 240 may include one or more devices for enabling communication with a user such as an administrator. For example, the user interface 240 may include a display, a mouse, a keyboard, a touchscreen, buttons, camera, microphone, vibrator, haptic engine, etc. In some embodiments, the user interface 240 may include a command line interface or graphical user interface that may be presented to a remote terminal via the communication interface 250.

The sensors 245 may be virtually any device capable of sensing parameters from the user, the environment, etc. as described herein such as, for example, accelerometers, gyroscopes, conductance sensors, optical sensors, temperature sensors, microphones, cameras, etc. In some embodiments, the sensors 145 may share hardware in common with the user interface 240.

The communication interface 250 may include one or more devices for enabling communication with other hardware devices. For example, the network interface 250 may include a network interface card (NIC) configured to communicate according to the Ethernet protocol. Additionally, the communication interface 250 may implement a TCP/IP stack for communication according to the TCP/IP protocols. Various alternative or additional hardware or configurations for the communication interface 250 will be apparent. In some embodiments, the communication interface 250 may include an NFC, Bluetooth, or other short range wireless interface. Various alternative or additional hardware or configurations for the communication interface 250 will be apparent.

The storage 260 may include one or more machine-readable storage media such as read-only memory (ROM), random-access memory (RAM), magnetic disk storage media, optical storage media, flash-memory devices, or similar storage media. In various embodiments, the storage 260 may store instructions for execution by the processor 220 or data upon with the processor 220 may operate. For example, the storage 260 may store an operating system 261 for controlling various basic operations of the hardware 200.

Where the device 200 implements a sensor device 110, the storage 260 may also include sensor polling instructions 262 for periodically on the acquisition of new data, polling the sensors 245 for new raw data. The storage 260 may also include parameter extraction algorithm application instructions 263 for executing one or more parameter extraction algorithms 264 to extract additional parameters from the parameters obtained by the sensor polling instructions, other parameter extraction algorithms 254, or from other devices. In some embodiments, the set of parameter extraction algorithms 264 may be supplemented by addition of new algorithms 264 (e.g., as a result of subscribing to a new service). To enable such extension of functionality, the parameter extraction algorithm application instructions 263 are adapted to call each of the parameter extraction algorithms 264 during run-time. For example, in some embodiments, the parameter extraction algorithms 264 may be written using an interpreted code (e.g., Java or a proprietary device code) while the parameter extraction algorithm application instructions 263 include or invoke an appropriate interpretation engine (e.g., Java runtime environment or other interpreter). As another example, the parameter extraction algorithms may instead be compiled code while the parameter extraction algorithm application instructions 263 may include code that calls each parameter extraction algorithm in turn. In some embodiments, the extraction algorithm application instructions 263 may be as simple as code that calls each parameter extraction algorithm 264 in sequence. Various additional organizations for expanding algorithm-based functionality will be apparent.

The storage 260 may also include parameter reporting instructions 265 for transmitting parameters sensed by the sensor polling instructions 262 or extracted by the parameter extraction algorithms 264. For example, where the sensor device 110 is an indirect reporting sensor device 114, the parameter reporting instructions 265 may cause the processor to transmit parameters to a reporting framework 115. Where the sensor device 110 is a direct reporting sensor device 112, the parameter reporting instructions 265 may cause the processor 220 to transmit parameters to one or more device identified or authorized in the parameter reporting configurations 266. The parameter reporting instructions 265 may operate periodically, upon the acquisition of new parameters, or upon receiving a pull request from another device.

In some embodiments, such as those wherein the sensor device 110 provides some output of at least the locally gathered or extracted parameters, the storage 260 also includes parameter output instructions 267 for causing display or other output of parameters, for example, upon request by the user. In embodiments wherein the sensor device 110 is also a consumer output device 130, the parameter output instructions 267 may additionally effect output of parameters or other information received from other devices via the remote parameter receipt instructions 268. Such remote parameter receipt instructions 268 may operate periodically, upon request by the user (e.g., to sync with service providers or to display a parameter that is remotely obtained), or upon indication from the remote device of the availability of such parameters to request, receive, interpret, store, or otherwise process remote parameters.

Where the device 200 is a consumer configuration device 140 or consumer output device 130, the storage 260 may include a web browser 271 and one or more apps 272. It will be appreciated that various functionalities described herein may be accomplished alternatively via a web browser 271 interacting with a remote webserver or an app 272 interacting with a server via an API. For example, to provide a consumer with access to a marketplace offered via a service broker framework 120, a web browser may be pointed to a URL set up for the marketplace or a marketplace app may be downloaded and opened for communicating with the marketplace server. Similarly, to enable a consumer to receive output from a service (e.g., parameters, history, graphs, charts, coaching programs), the web browser 271 may be pointed to a URL set up for the service application device or an app 272 may be downloaded and run for presenting a portal to the service.

Where the device is a service application device 125, the storage 260 may include input parameter receipt instructions 281 for requesting, receiving, interpreting, or otherwise processing input parameters from on or more devices. For example, the input parameter receipt instructions 281 may communicate with a sensor device 110, reporting framework 115, service broker framework 120, or other service application device 125 to receive such input parameters. After receiving the parameters, a service algorithm 282 processes the parameters (potentially, along with previously received parameters and information for the user) to generate outputs such as new parameters and other information to be presented to a user. The specific function of the service algorithm 282 will vary greatly depending on the particular service being offered by the service provider. As will be understood, the various methods described herein facilitate the provision of virtually any service in connection with wearable devices and other sensor devices 110. A web server 283 or output presentation instructions 284 enable the communication of the output to interested parties, such as the consumer, the service broker framework 120, other service application devices 125, and other third parties. For example, the output presentation instructions 284 may include scripts and markup for use in conjunction with the web server to provide the consumer a web-based interface to the service. Alternatively, the output presentation instructions 284 may push data to an app of the consumers for presentation therethrough. Output parameter reporting instructions 285 may specifically report individual parameters back to the service broker framework 120 or other service application devices 125 when such output parameters are used or otherwise useful as input to other services.

It will be apparent that various information described as stored in the storage 260 may be additionally or alternatively stored in the memory 230. In this respect, the memory 230 may also be considered to constitute a “storage device” and the storage 260 may be considered a “memory.” Various other arrangements will be apparent. Further, the memory 230 and storage 260 may both be considered to be “non-transitory machine-readable media.” As used herein, the term “non-transitory” will be understood to exclude transitory signals but to include all forms of storage, including both volatile and non-volatile memories.

While the device 200 is shown as including one of each described component, the various components may be duplicated in various embodiments. For example, the processor 220 may include multiple microprocessors that are configured to independently execute the methods described herein or are configured to perform steps or subroutines of the methods described herein such that the multiple processors cooperate to achieve the functionality described herein. Further, where the device 200 is implemented in a cloud computing system, the various hardware components may belong to separate physical systems. For example, the processor 220 may include a first processor in a first server and a second processor in a second server.

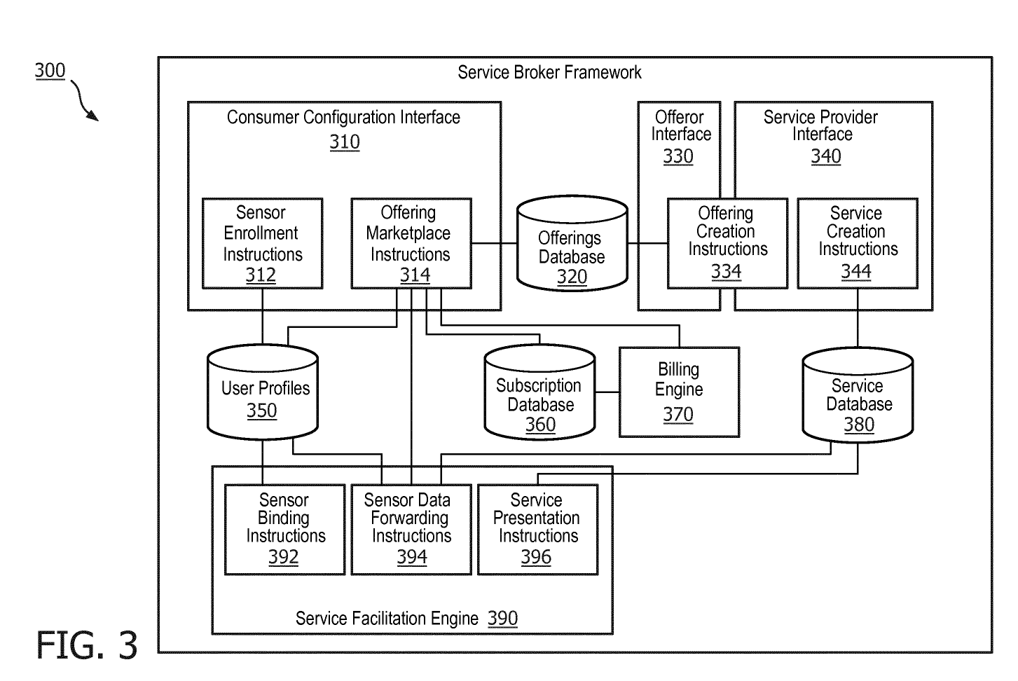

FIG. 3 illustrates an example service broker framework 300 for implementing the service broker framework 120 of FIG. 1. The service broker framework 300 may describe the contents of the storage 260 when the hardware device 200 of FIG. 2 implements the service broker framework 120 of FIG. 1. In some alternative embodiments, the various functions of the service broker framework 300 may instead be distributed across multiple devices; for example, a first VM may implement the interfaces 310, 330, 340 while a second VM may implement the service facilitation engine 390. Various additional arrangements will be apparent.

As shown, the service broker framework 300 includes three interfaces: a consumer configuration interface 310, an offeror interface 330, and a service provider configuration interface 340, each of which may be implemented by various sets of functions defining the separate functions thereof. Various additional sets of instructions for inclusion in these interfaces 310, 330, 340 will be apparent such as, but not limited to, account creation instructions, billing configuration instructions, usage statistics instructions, etc.

As shown, the consumer configuration interface 310 includes sensor enrollment instructions 312 for enabling a user to enroll their sensor devices for use in conjunction with services offered via the service broker framework 300. Upon learning about or authorizing a new sensor device, an identification of the device (potentially along with other information such as the device address, reporting framework address, or types input parameters available from the sensor device) is recorded in the user profile 350 for that user. From here, the user profile may be consulted by other components to determine the types of inputs available for the user (e.g. for recommending or filtering offerings for presentation to the user) or for communicating with the sensor device (e.g. for binding the sensor device other services). As used herein, the term “user profile” will be understood to refer to a record or collection of records that collectively carry information related to a user and their use of the service broker framework 300.

Various approaches to enrolling a new sensor device may be utilized by the sensor enrollment instructions. For example, in some embodiments, the sensor enrollment instructions may receive an identifier for a sensor device from a consumer configuration device (e.g., as manually typed in by the user; captured by a camera via a barcode, QR code, or using optical character recognition; or received by the consumer configuration device via short-range communication such as NFC or Bluetooth) or directly from the sensor device itself (e.g., as stored in memory at the time of manufacturing or registration with a reporting network). In some embodiments, the identifier may be or otherwise include a network address such as a MAC address or IP address. In some embodiments where the identifier is, at least in part, dynamic (e.g., an IP address), the sensor enrollment instructions may periodically re-execute to update the dynamic portion of the identifier. Upon receiving the identifier the sensor enrollment instructions 312 may verify the device through communication with, for example, a reporting framework. Additionally, the sensor enrollment instructions may receive authorization in association with the device by, again, communicating with another device such as the reporting framework or the sensor device itself.

The offering marketplace instructions 314 may perform various functions in relation to presenting available offerings from the offerings database to a consumer for selection, purchase, or subscription. For example, in various embodiments, the offering marketplace instructions presents a storefront via a web browser or app on the consumer configuration device. Via this storefront, the consumer may browse, search, select various offerings for services and products. In some embodiments, the offering marketplace instructions 314 additionally include a recommendation engine for recommending offerings to the consumer. For example, the offering marketplace instructions 314 may identify offerings for services for which the user profile 350 indicates that the user is able provide sufficient, enhanced, or optimal inputs. As another example, the offering marketplace instructions 314 may use information about the consumer (e.g., available inputs, parameter values, demographics, health records, app usage, etc.) in conjunction with a rule set or learned model to recommend offerings that are individually tailored to the user. For example, a 50 year old male with a history of heart attacks may be recommended a heart health coaching service while an 18 year old who logs a relatively large amount of time using a particular social networking app may be offered a service for pushing fitness achievements to the social networking app for publication.

The offeror interface 330 includes offering creation instructions 334 while the service provider interface 340 includes service creation instructions 344. It will be apparent that, in some embodiments, the roles of offeror and service provider may be held by a single party. For example, an algorithm developer may, themselves, offer their algorithm for subscription. In such embodiments, the offering creation instructions 334 may form part of the service provider interface 340 and, in some such embodiments, may be part of the service creation instructions 344. For example, the service provider may wish to define the new service and simultaneously, concurrently, or otherwise at the same time, offer then new service for subscription (potentially as part of a package offering with other services, hardware, etc.). In some embodiments, an offeror may be a party other than a service provider such as, for example, a physician, an advertiser, an insurance company, a data collector, etc. As such, the offering creation instructions 334 may provide an interface for selection of one or more services offered by other service providers as well as for identification of payment particulars (e.g., where the offeror is subsidizing or covering the cost of the service to the consumer).

Upon a consumer selecting an offering including a subscription service, the offering marketplace instructions 314 writes a subscription record to the subscription database 360 which, in turn, is read by the billing engine 370 to effect payment to appropriate parties. Similarly, if the offering includes an immediate purchase item (e.g., new hardware or one-time-payment service), the offering marketplace instructions instructs the billing engine 370 to immediately process the payment. Further, upon adding a new service for a consumer, the offering marketplace instructions 314 update the user profile 350 to identify the new service or to otherwise configure the consumer's account for receiving the new service. For example, the offering marketplace instructions 314 may store, in the user profile, and indication that a particular set of inputs are to be shared with a particular set of servers.

A service facilitation engine 390 may also be deployed to help direct the various communications that enable the distributed performance of services. In some embodiments, such as for a service that will directly receive input parameters without the service broker framework 300 acting as an intermediary. The sensors devices may be “bound” to the service by establishing such direct communication (e.g., between a service application server and sensor devices or reporting frameworks). For such services, sensor binding instructions 392 may facilitate the binding by, for example, informing the service application server of the sources of the input parameters (e.g., network addresses) or informing the input devices or reporting frameworks of the destinations of their input parameters (e.g., network addresses). The sensor binding instructions may also provide an authorization token, password, key, etc. to one or more of these devices where the communications are to be secured.

In some embodiments, such as for a service that receives input parameters via the service broker framework 300, sensor data forwarding instructions 394 may receive input from the various sensor devices and, according to the configurations in the user profile 350, forward the inputs to their appropriate destinations (e.g., service application servers or third party servers). In some embodiments, the sensor data forwarding instructions 394 may perform some preprocessing (e.g., according to the configuration for the service in the service database) prior to such forwarding. In a similar manner, in some embodiments, the service facilitation engine 390 may facilitate output communications to the consumer output device; as such, service presentation instructions may receive output, perform preprocessing as defined in the service database 380 (e.g., creation of an HTML page), and send the output to an output device known for the consumer.

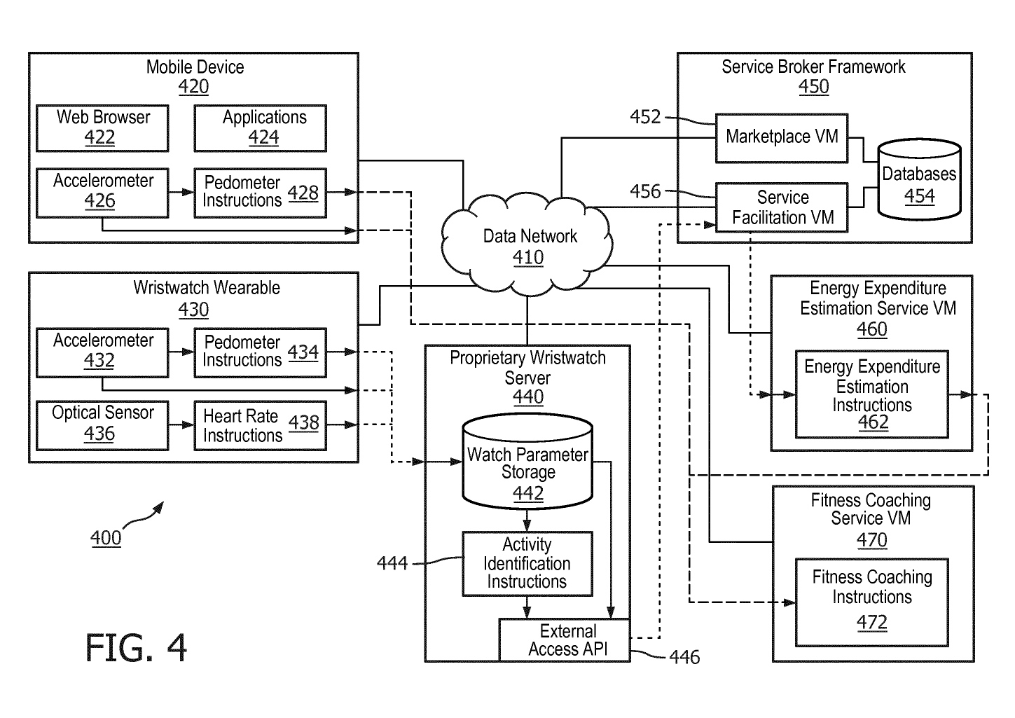

FIG. 4 illustrates an example of an environment 400 for providing wearables as a service. The environment 400 may include an example implementation of the example system 100 described above. For example, the mobile device 420 may implement a direct reporting sensor device 112, consumer output device 130, and consumer configuration device 140; the wristwatch wearable 430 may implement an indirect reporting sensor device 110; the proprietary wristwatch server 440 may implement a reporting framework 115 and sensor device 110 (by virtue of the server 440 extracting additional parameters); the service broker framework 450 may implement the service broker framework 120; the energy expenditure estimation service VM 460 may implement a service application device 125 and a sensor device 110 (by virtue of the server 440 extracting additional parameters); and the fitness coaching service VM may implement a service application device 125. These devices may communicate via a data network such as, for example, a LAN, carrier network, data center network, or the Internet. In some embodiments devices may communicate directly with each other via a wired or wireless connection (e.g., the mobile device 420 and wristwatch wearable device may communicate via NFC or Bluetooth).

While various embodiments described herein may describe computer instructions as performing various functionalities, it will be apparent that such functionalities are actually performed by hardware, such as a microprocessor that may be executing the instructions or an ASIC hardwired to perform the functionality without instructions. The various devices in the environment 400 may be implemented with hardware such as that described with respect to FIG. 2. Further, while the following embodiments describe a particular example of services for calorie expenditure estimation and fitness coaching, systems designed herein may be used for providing virtually any type of service in connection with a wearable device.

As shown, a mobile device includes a web browser 422 or applications 424 for providing various interfacing between the user and the other devices. For example, an application 424 may provide access to the marketplace VM 452 for subscription to new services while the web browser may provide access to a web-based coaching portal of the fitness coaching service VM 470. The mobile device also includes an accelerometer 426 for recording motion of the mobile device 426 and on-board pedometer instructions 428 (which may have been installed on the mobile device by or in connection with the service broker framework 450) for using the raw accelerometer data to estimate a number of steps taken by the user. The raw accelerometer data and pedometer data are available in an open manner to any device that is properly authorized by the user of the mobile device. As such, the mobile device is a direct reporting sensor device.

The user also owns and wears a wristwatch wearable device that includes an additional accelerometer 432 as well as an optical sensor 436 oriented toward the skin of e user to detect color changes. Pedometer instructions 434 (which may have been installed on the mobile device by or in connection with the service broker framework 450) interpret the raw accelerometer 432 data to output an estimation of the number of steps taken. Alternatively, the pedometer instructions 428 of the mobile device 420 may receive raw data from both accelerometers 426, 432 (e.g., as facilitated by the service broker framework 450) to give an improved estimation of steps taken. Heart rate instructions 438 (which may have been installed on the mobile device by or in connection with the service broker framework 450) interpret the raw optical data to extract a heart rate parameter. The steps and heart rate parameters, as well as the raw accelerometer data, are provided to the proprietary wristwatch server 440 for storage and further processing. The wristwatch wearable 430 may not be configurable to share data with any other devices and, as such, may be considered an indirect reporting sensor device.

The proprietary wristwatch server may be a server, blade, or VM operated, for example, by a manufacturer of the wristwatch wearable 430. Upon receiving parameters from the wristwatch wearable 430, they may be stored in a watch parameter storage 442 and later used by activity identification instructions 444 to identify a particular activity in which the user is engaged. For example, wristwatch accelerometer data may be used in conjunction with a trained model to distinguish playing tennis from kayaking. In some embodiments, the service broker framework 450 may facilitate provision of additional input parameters (e.g., accelerometer data from the mobile device 420) to the proprietary wristwatch server 440 to improve or activate operation of the parameter extraction algorithms or other services offered by the device manufacturer. The proprietary wristwatch server 440 additionally includes an external access API for providing some or all of these parameters to the service broker framework 450 or other devices.

The service broker framework 450 includes a marketplace VM 452 that provides an interface for the web browser 422 or applications 424 to select, purchase, subscribe to, add, or otherwise configure services and offerings from the databases 454 for the user of the mobile device 420 and wristwatch wearable 430. Thereafter, a service facilitation VM 456 may perform various actions so that the proper inputs may be provided to the appropriate servers. It will be apparent that, in some embodiments, the framework 450 may include only a single VM or may include additional VMs.

An energy expenditure estimation service VM 460 includes energy expenditure estimation instructions 462 for executing a parameter extraction algorithm that estimates a number of calories burned from various inputs. Similarly a fitness coaching service VM 470 includes fitness coaching instructions 472 for processing various input data to provide coaching messages to the user.

In the example shown, the energy expenditure estimation service VM may use heart rate, pedometer, and activity parameters to estimate an energy expenditure parameters These three input parameters may be available from the external access API 446 of the proprietary wristwatch server, but the energy expenditure estimation service VM 460 may not be able to access the API 446 itself (e.g., it may not be permitted by the manufacturer from accessing this information directly, or it may not be configured to perform such access). Instead, the service facilitation VM 456 receives the three input parameters (e.g., having subscribed to updates via the API 446 or by periodically polling the API 446), packages them into a message, and sends the message to the energy expenditure estimation service VM 460 for processing according to the offered service.

Following the illustrated example, the fitness coaching service VM 470 may utilize energy expenditure information along with pedometer data and accelerometer data from the mobile device 420 to provide the coaching service. In this instance, rather than acting as an intermediary, the service facilitation VM 456 facilitates the proper input distribution by binding the sensor devices to the fitness coaching service VM 470 by configuring the mobile device 420 to send parameters to the fitness coaching service VM 470; configuring the energy expenditure estimation service VM 460 to send parameters to the fitness coaching service VM 470; configuring the fitness coaching service VM 470 to request parameters from the mobile device 420; configuring the fitness coaching service VM 470 to request parameters from the energy expenditure estimation service VM 460; or some combination thereof. Thereafter, the fitness coaching instructions 472 may process the input parameters to produce output (e.g. coaching messages and progress charts) to be delivered to the user via the web browser 422, applications 424, or some other channel.

It will be apparent that various modifications to the specific example described are possible. For example, in some embodiments, the service facilitation VM 456 may facilitate input parameter distribution by binding a service device to one sensor device acting as an intermediary between the same service device and another sensor device. Alternatively, in some embodiments wherein the service facilitation VM 456 must act as intermediary for at least one input type for a service, the service facilitation VM 456 may act as intermediary for all input types for that service even if direct binding for other input types may be possible.

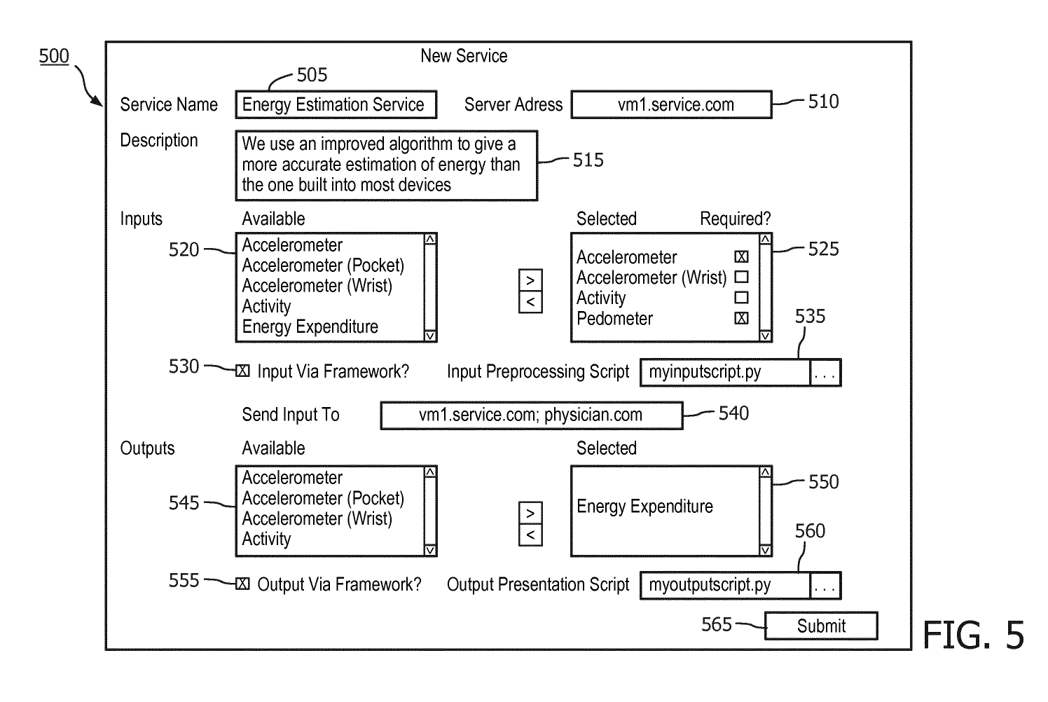

FIG. 5 illustrates an example of an interface 500 for defining a new service. This interface 500 may be provided, for example, by the service creation instructions 344. The interface 500 may be useful, for example, where the service provider has externally hosted an application for providing a service to inform the service broker framework of the location of the service and the types of inputs that are required or may be accepted by the service. In various other embodiments, such as those embodiments wherein the service is fully hosted within the service broker framework, the service may be identified by an internally unique name upon creation and information about inputs, outputs, and other metadata may be gathered directly from the hosted application (e.g., by analysis of code or API messages sent by the hosted service application) or in some other manner. In some embodiments, the interface 500 may be useful to create a “mashup” app wherein the service provider selects two or more existing services and provides a format (e.g., HTML or other markup) for outputting the results of these services in a single view. As such, the interface 500 may be modified to select from existing services to repackage. In such embodiments, and other embodiments wherein dependency services are packaged into a new service or a new offering, the service broker framework may automatically compute the offering price to include the price of the dependency services and automatically remit payment for each offering purchase to the appropriate parties for each of these dependency services.

The interface 500 includes a name field 505 for identifying the name of the service, a server address field 510 for identifying where the service is hosted, and a description field 515 for inputting a textual description of the service for presentation to consumers. To define the inputs that are required or otherwise usable by the service, an available inputs list 520 allows selection of types of inputs (e.g., from a list of all input types known to the service broker framework) to be added to the selected inputs list 525. As shown, each selected input in the list 525 may be indicated as a required input. Various alternative controls for identifying input types will be apparent.

Thus, as shown, these service broker framework decouples the input type from the specific sensor devices that provide the input parameters for the service provider. Rather than considering and enumerating the potential sources for input parameters, the service provider need only identify the type of input while the service broker framework facilitates direction of the appropriate types of input data to the service. In some embodiments, input types may be arranged in a hierarchy. For example, as shown, an accelerometer input type may be further classified as pocket-held accelerometer or a wrist-worn accelerometer. In some such embodiments, requirements for a parent input type may be fulfilled by a child (or grandchild, etc.) input type. For example, as shown, the service being defined requires accelerometer input data; if a pocket-held accelerometer data (“Accelerometer (Pocket)”) is available, this input data will fulfill the requirement. Similarly, wrist-worn accelerometer data would fulfill this requirement and, additionally, fulfill the optional input for wrist-worn accelerometer data (e.g., improving the performance of the service by providing input that is better suited for the service).

A checkbox 530 indicates whether the input parameters listed in the selected list 525 should be processed through the service broker framework as an intermediary. In some embodiments, the service broker framework may act as an intermediary in some cases even when the checkbox 530 is unselected. For example, in some cases, a user's sensor device for providing a particular input type will not provide input data to other devices; in such a case the service broker framework may nonetheless act as an intermediary, obtaining the input data and providing it to the appropriate servers. An input preprocessing script field 535 may be used to identify one or more scripts to be uploaded and executed prior to forwarding the collected input parameters. An input recipient field 540 identifies one or more servers to which the collected input should be forwarded. For example, as shown, input will not only be forwarded to the service application server, but also a physician server. In some embodiments, this field 540 may be parameterized for evaluation on a per-consumer basis. For example, rather than defining “physician.com,” a value of % PhysicianServer % may be interpreted as indicating that the input parameters should be transmitted to a server for a particular physician configured for the user (e.g., in the user's profile).

In a manner similar to the inputs, an available outputs list 545 provides a list of output data types for selection and inclusion in the selected output parameter list 550. Thus, the decoupling of parameters from particular sensor devices is further facilitated by allowing the service provider to define their output parameters via the same taxonomy used for input parameters, thereby facilitating the use of the present service as an input to additional services. A checkbox 555 indicates whether the output of the service is to be delivered to the consumer output device via the framework and if so, an output preprocessing script field 560 may be used to identify one or more scripts to be uploaded and executed prior to forwarding the output (e.g., output parameters and other output) to the consumer output device. Various additional input items will be apparent such as, for example, an input field for defining the consumer output device (e.g., by specific models, device type, output capabilities, etc.) or communication channels (e.g., a website, an app via an API, email, text message, etc.). Finally, a submit button 565 allows the service provider to commit the new service to the database (or for validation prior to being added to the database of available services).

In embodiments wherein the service provider is able to define an offering at the same time as defining a new service, the interface 500 may include additional input fields, such as one or more of the fields described with respect to the example new offering interface. Alternatively, submission of the form defined in the interface 500 may be followed by presentation of the offering interface 600 which may be prepopulated with information about the service being defined.

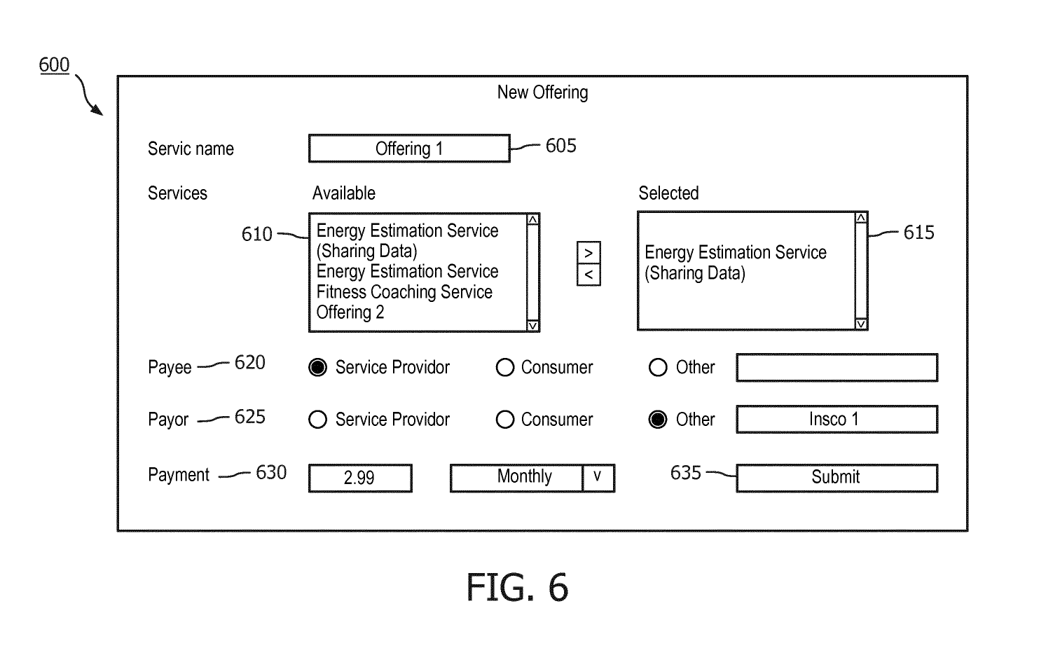

FIG. 6 illustrates an example of an interface 600 for defining a new offering. This interface 600 may be provided, for example, by the offering creation instructions 334 and may be used by a service provider or other offeror for offering a service. For sale on the service marketplace.

An offering name field 605 allows the offeror to input a name for the offering and an available services field may list one or more services for selection to be included in the selected services list 615 and as part of the offering. For example, the available services field 610 may list all services registered with the service broker framework, all services listed as “public” for inclusion in offers, or all services “owned” by the offeror within the service broker framework. In some embodiments, other offerings may be included as “services” as well, thereby importing the services or payment information previously defined for the other offering into the present offering. Various alternative controls for identifying one or more services for selection will be apparent. As shown, a single services has been selected: a version of “Energy Estimation Service” that shares acquired data with another party such as an insurance company.

A payee field 620, payor field 625, and payment field 630 are useable to define the payments that will be due upon acceptance of the offering being defined. For example, as shown, upon a consumer selection of the offering, a party identified in the service broker framework as “Insco1” will pay $2.99 every month to the service provider(s) of the selected services. As can be seen, various alternative arrangements are possible using the controls illustrated such as, for example, payment by the consumer to a service provider or payment to the consumer by another party. Additionally, other payment periods such as one-time, weekly, yearly, etc.

Various alternative sets of controls for defining similar or more complex payment schemes will be apparent. For example, alternative controls may enable definition of different amounts to multiple payees. In some such embodiments, some of these payment values or payees may be automatically filled out automatically upon selection of some services. For example, if a service (or other offering) is selected for inclusion that is “owned” by a different service provider, that service provider may be automatically added as a payee along with a desired payment previously identified by that service provider for the service. Similarly, various alternative embodiments may enable definition of multiple payors (e.g., if a third party wants to pay only part of the service cost) and respective amounts to be paid upon offering selection.

Various additional modifications will be apparent. For example, in some embodiments, eligibility criteria may be defined via the interface 600 to indicate when a consumer will be shown or otherwise able to accept a given offering. Such criteria may include information such as association with a particular insurance company or physician, participation in or subscription another service, ownership of a particular device, etc. As another alternative, in some embodiments the interface 600 may enable the provision of hardware or other real goods to the purchaser. As such, input fields for defining the hardware, its capabilities, fulfilling party, server to which orders will be submitted, etc. may also be included.

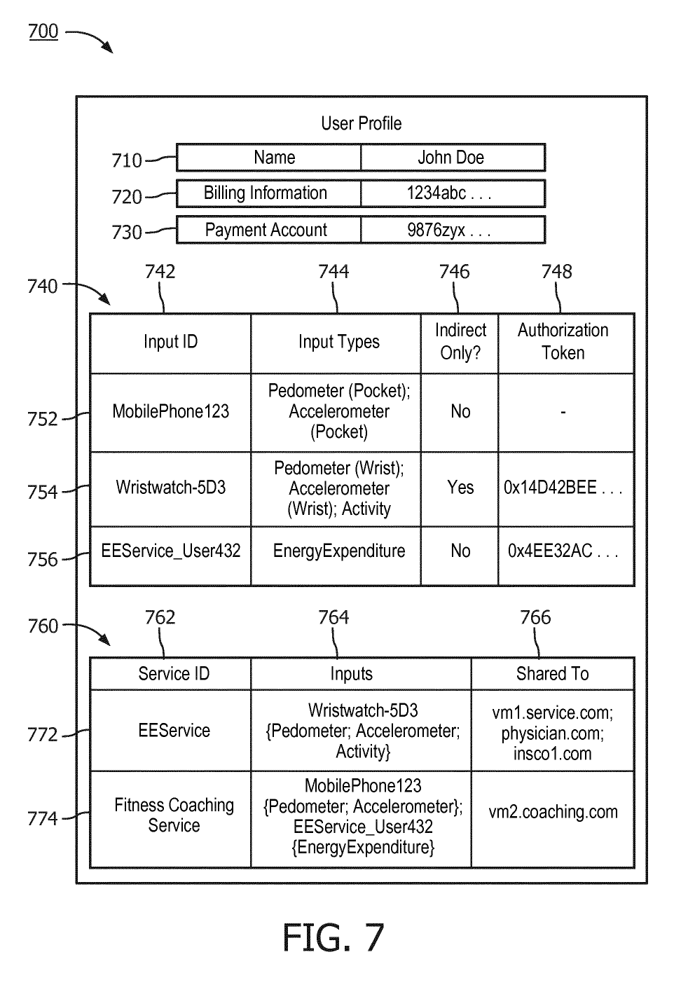

FIG. 7 illustrates an example of a data arrangement for defining a user profile 700. For example, the user profile 700 may be stored as part of the user profiles 350 of FIG. 3. While the user profile 700 is shown as a single record, it will be apparent that in other embodiments a “user profile record” may be distributed between multiple types of records. For example, a first record may specify user demographic information, a second set of records may identify enrolled sensors for the user, and a third set of records may store sharing configurations for the user. Further, the user profile 700 may be an abstraction and may be implemented as various data arrangements (or combinations thereof) such as, for example, tables, arrays, linked lists, trees, flat text, etc.

As shown, the user record includes a name field 710 for storing a name of the user, a billing information field 720 for storing information regarding a payment instrument of the user (e.g., a credit card, debit card, bank account, payment processor account, etc.) for use in paying for offerings, and a payment account field 730 for storing information regarding an account (e.g., bank account, payment processor account, etc.) to which payments made to the user will be made. In some embodiments, the billing information field 720 and payment account field 730 may be combined when the user may make and accept payments using the same account. Alternatively, in some embodiments, payments may not be made to the user at all and, as such, the payment account field 730 may be omitted.

The user profile 700 also includes a sensor devices record set 740 for describing the sensors enrolled for the user. The sensor devices record set 740 includes an input id field 742 for identifying an enrolled sensor device (e.g., a user-provided name, an identifier generated by the service broker framework, an identifier used by another device such as a reporting framework, or a globally unique identifier), an input types field 744 for identifying (e.g., using the same parameter type taxonomy used by the service provider to specify inputs and outputs to a service) input parameters available from the sensor device, and indirect field 746 for identifying whether a sensor device is a direct reporting or indirect reporting sensor device, and an authorization token 748 field for storing one or more tokens (e.g., encryption keys, passwords, API tokens, etc.) needed for accessing the data from the sensor device. It will be apparent that additional or alternative information about each sensor device may be provided by the sensor devices record set 740 such as, for example, one or more network addresses of the sensor device, one or more network addresses of a reporting framework, an indication of whether the service broker framework must act as an intermediary to other services (e.g., between the service application device and a direct reporting sensor or reporting framework)

As an example, a first record 752 indicates that a device named “MobilePhone123” is able to provide two input types: pocked-carried pedometer and pocket-carried accelerometer data. This information is directly reported by the sensor device and is not associated with any authorization tokens. In various embodiments, the record 752 may correspond to the mobile device 420 of FIG. 4.

A second example record 754 indicates that a device named “Wristwatch-5D3” provides three input parameter types: wrist-worn pedometer, wrist-worn accelerometer, and activity data. This information is only obtainable from a reporting framework associated with the device using the defined authorization token. In various embodiments, the second record 754 may correspond to the wristwatch wearable 430 or proprietary wristwatch server 440 of FIG. 4. As will be noted for the context of the example of FIG. 4, this record 754 identifies input parameters available from two different sensor devices: the wristwatch wearable 430 creates the accelerometer and pedometer data, while the proprietary wristwatch server 440 extracts the activity data. For the purposes of sharing or for the purposes of user presentation, however, these two sensor devices may be collapsed into a single “device” record because all three parameters will be obtained from the reporting framework (due to indirect reporting) or because the user may consider the complete solution offered by the manufacturer (device 430 and reporting framework 440) to constitute a single device which they purchased and use.

A third example record 756 illustrates that some “sensor devices” may correspond to services configured for the user, rather than an additional physical device carried by the user. For example, as shown, a “device” named “EEService_User432” (e.g., specifying data reported for user ‘432’ by a service named ‘EEService’) provides an energy expenditure estimation for a user and can be configured for direct reporting to other devices using a listed authorization token. In various embodiments, this record 756 may correspond to the energy expenditure estimation service VM 460 of FIG. 4.

The user profile 700 also includes a set of sharing records 760 for defining how the service broker will behave as an intermediary for one or more services of the user. As such, the set of sharing records 760 include a service ID field 762 for identifying a service to which a sharing configuration applies, an inputs field 764 for identifying one or more inputs to be shared, and a ‘shared to’ field 766 for identifying one or more devices to which the inputs will be shared. As shown, the inputs field 64 may specify individual devices from which input data is to be sent, rather than by relying solely on the decoupled taxonomy. Such an arrangement may be beneficial when similar input parameter types are available from multiple devices and the user (or other device or entity) chooses only one such source to provide the information to the service. Alternatively, in some embodiments, the inputs field 764 may also be decoupled from the specific devices and a decision may be made elsewhere for determining which device(s) should provide the specific inputs (e.g., forward inputs from all devices, forward from sensor devices that most frequently provide new input parameters, forward from sensor devices which are known to provide best performance of the service among the available devices, etc.).

As a first example, a record 772 indicates that, for a service known as “EEService,” the three parameters obtained by the Wristwatch-5D3 device should be forwarded to three devices located, respectively, at vm1.service.com, physician.com, and insco1.com. In some embodiments, the record 772 may correspond to the service offered by the energy expenditure estimation service VM 460 of FIG. 4.

In some embodiments and cases, such as those wherein an input preprocessing script is defined for “EEService” (e.g., in a service record for that service), preprocessing may be performed on the input data prior to forwarding. Further, in some embodiments, such as those wherein the service “EEService” includes a parameterized definition of the parties to which information will be shared, the values in the shared-to field 766 may be filled in according to information elsewhere in the user profile. For example, “physician.com” may point specifically to the server of the user's physician, while the EEService may simply define that input is to be shared to % PhysicianServer %. Thus, this (and other values) may vary from user to user for the same service.

A second example record 774 indicates that for a service known as “Fitness Coaching Service,” the two parameters obtained by the MobilePhone123 device as well as the parameter obtained by the EEService_User432 “device” should be forwarded to the devices located at vm2.coaching.com. In various embodiments, the record 774 may correspond to the service offered by the fitness coaching service VM 470 of FIG. 4 In some alternative embodiments, the set of sharing records 760 may only include records for which the service broker framework acts as an intermediary. As such, in the example of FIG. 4 where the mobile device 420 and energy expenditure estimation service VM 460 transmit input parameters directly to the fitness coaching service VM 470, this record 774 may be omitted in some embodiments. Instead, in some such embodiments, the service broker framework may simply perform sensor binding and thereafter perform no further action in terms of facilitation until the service is discontinued, at which point the service broker framework may facilitate sensor unbinding.

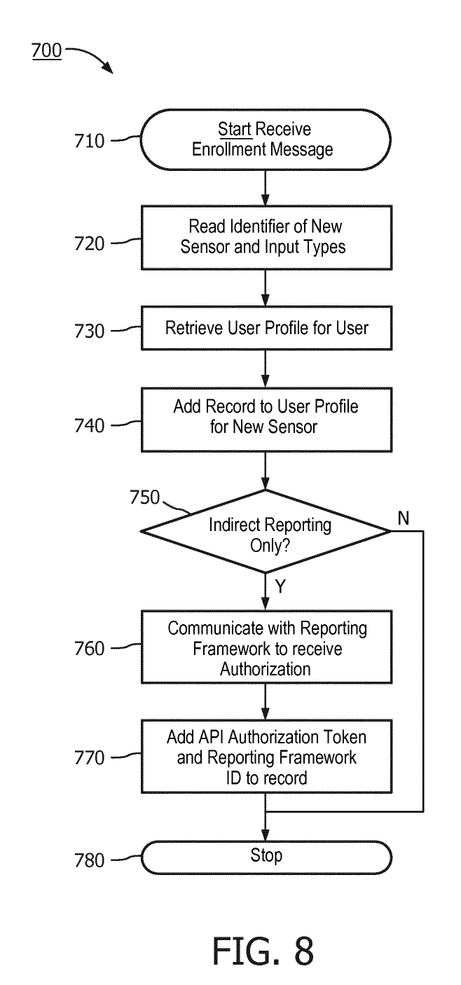

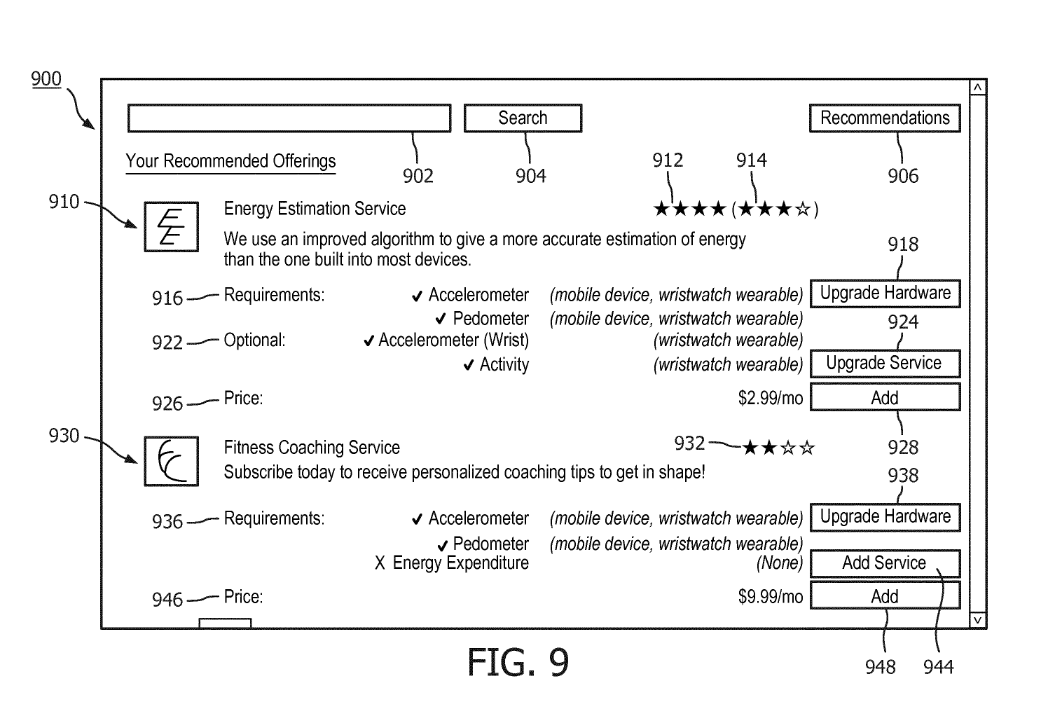

FIG. 8 illustrates an example of a method 800 for enrolling a sensor device for a user. In various embodiments, the method 800 may be performed by and service broker framework and, in some embodiments, may correspond to the sensor enrollment instructions 312 of FIG. 3. Various alternative arrangements and methods for enrolling a sensor in a service broker framework will be apparent.

The method begins in step 810 where the service broker framework receives an enrollment message from the user. The enrollment message may be transmitted by the sensor device being enrolled or by another device operated by the user (e.g., a mobile phone, tablet, pc, reporting framework, etc.). The enrollment message may be sent, for example, as a result of a user filling out and submitting a form, through operation of software for obtaining and reporting information about a sensor device, or through operation of the sensor device (e.g., by “phoning home” after initial power on). Next, in step 820, the service broker framework reads the identifier(s) for the device along with the advertised input parameter types from the enrollment message. Alternatively, in some embodiments, the enrollment message may not include an advertisement of input parameters and, instead, the service broker framework may reference a database listing the known input parameter types provided by the type of sensor device identified.

In step 830, the service broker framework retrieves a user profile for the user identified by the enrollment message and, in step 840, the service broker framework adds a new record to the user profile to represent the new device. This new record may include information such as the identifiers and available input types. As such, the record created in step 840 may correspond to a record of the set of sensor device records 740 of FIG. 7. Next, in step 850, the service broker framework determines whether the identified sensor device is an indirect reporting device. Again, this information may be carried by the enrollment message or cross referenced by the service broker framework based on information known about the particular device being enrolled. If so, the service broker framework communicates with the reporting framework for the device to be enrolled 860 to obtain authorization to release input parameters to the service broker framework or other devices. For example, the service broker framework may transmit a token indicating the user's approval to allow such sharing or an identifier that the service broker framework may use to initiate separate communication with the user to obtain such approval. Thereafter, if the approval is or has been successfully obtained, the reporting framework returns an API authorization token which is stored in the record in step 870 along with an identifier (e.g., a network address or other ID) of the reporting framework. Thereafter, the API token may be used for requesting input parameters from the reporting framework. Finally, the method ends in step 880.

FIG. 9 illustrates an example interface 900 for browsing offerings. This interface 900 may be generating, for example, according the offering marketplace instructions 314 of FIG. 3 and may be presented via a web browser, app, or other client software running on a device of a consumer.

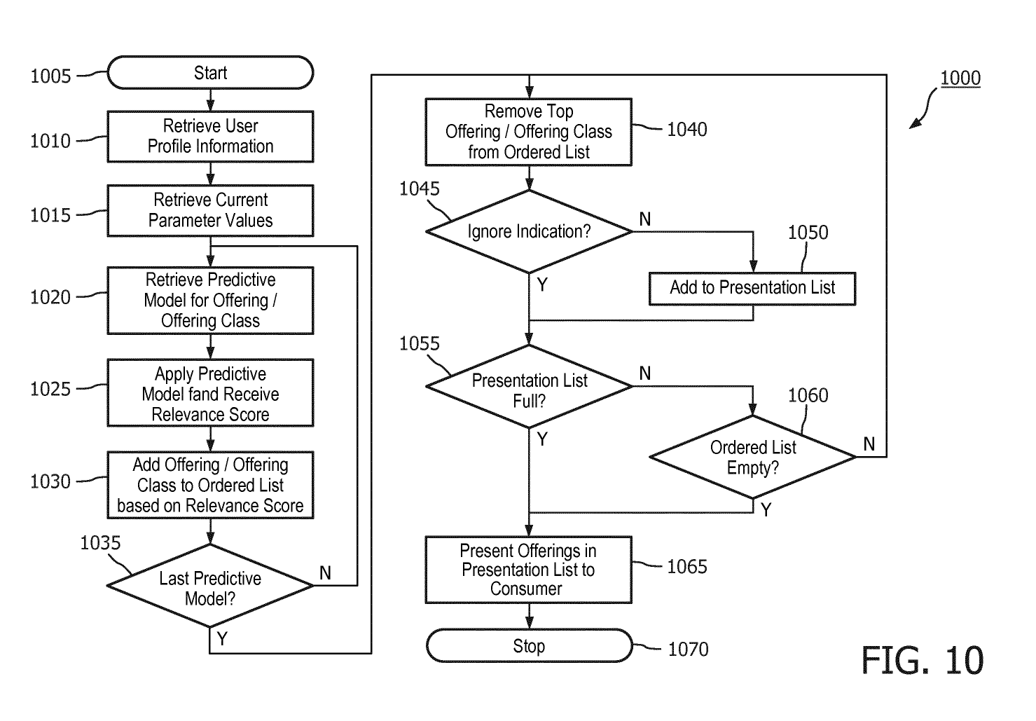

As shown, the interface 902 includes a search bar 902 and search button 904 for enabling a user to input a name or other keywords to locate offerings to browse. Various algorithms for conducting a search of an offerings databased will be apparent. For example in some embodiments, the search algorithm executed upon pressing the search button 904 may identify any offerings wherein one or more words input into the search bar 902 are located in the offering name or description, or in the name or description of any services associated with the offering. A recommendations button 906 requests that the service broker framework recommend one or more offerings for the user to browse. Again, various algorithms for performing such recommendations will be apparent, an example of which will be described in greater detail below with respect to FIG. 10. For example, the recommendation algorithm may locate offerings for which the user already has all or most of the sensor devices required for operation of the service enrolled or may employ a machine learning approach such as genetic algorithms, regression, neural networks, Bayesian networks, etc. to make recommendations based on information about the user.

The interface 900 shows two offering entries 910, 930 that describe offerings that include a single service. In the case where an offering includes two or more services or other items, various alternative arrangements for listing each element of the offering will be apparent. The first offering 910 is associated with the “Energy Estimation Service” and is associated with two ratings 912, 914 shown as star ratings, though various alternative rating mechanisms will be apparent. Specifically, two ratings 912, 914 may be shown to differentiate an overall rating from a rating that is more tailored to the specific user. As will be understood, various factors may affect the performance of a service such as whether optional input parameters are available or the quality of the measurements taken by the user's devices versus other similar devices. The ratings may be generated based on other users' reviews of the service. For example, as shown, a general rating 914 indicates that users of the service at large rate the service as three stars, while the personalized rating 912 indicates that users more similar to the viewing user rate the service as four stars. For example, the four star rating 912 may be the average rating when all optional input parameters are available from the user, while the three star rating 914 may be the average rating when only the required input parameters are available or may be the average of all user ratings regardless of the input parameters available.

A requirements section 916 indicates that the energy estimation service requires two input parameters, accelerometer data and pedometer data, both of which are available from either the user's mobile device or wristwatch wearable (or, alternatively, the interface 900 may indicate these values are available from devices “MobilePhone123” and “Wristwatch-5D3”). In some embodiments, the marketplace may identify on or more hardware upgrade offerings that are available in connection with the offering 910. For example, the user ratings upon which the star ratings 912, 914 are premised may tend to show that users having a different type of accelerometer device report even higher satisfaction. In response, if that type of accelerometer device is available for purchase via the service broker framework, an upgrade hardware button 918 may be displayed next to the particular input. Upon pressing the button 918, the additional hardware offering may be displayed for acceptance, for example, in a new window or in a pop up over the interface 900.

An optional inputs section 922 indicates that two types of input parameters, though not required, may be used by the service: wrist-worn accelerometer data and activity data, both of which are available from the user's wristwatch wearable (or, more precisely in the example of FIG. 4 but potentially hidden from the user, from the reporting framework). In a manner similar to the upgrade hardware button 918, an upgrade service button 924 may be provided next to one or more of the inputs to indicate that an offering is available for a service that will provide the input parameter that is generally associated with better service performance or user satisfaction. In the illustrated example, the service broker framework has located another service for estimating an “activity” input parameter that tends to improve the operation (or user satisfaction or some other metric) of the energy estimation service. Upon pressing the button 918, the additional service offering may be displayed for acceptance, for example, in a new window or in a pop up over the interface 900.

A price section 926 indicates that acceptance of the offering (and adding the associated energy estimation service for the user) will result in a monthly recurring charge of $2.99 to the user. Selection of the add button 928 may immediately accept the offering, add the offering to a shopping cart, or take the user to a checkout or configuration screen for the new service.

A second offering 930 is associated with only a single rating 932. This may be because a personalized rating is unavailable for the user and, instead, only a general rating is shown. Such a personalized rating may be unavailable, for example, if sufficient user input from users similar to the present user is unavailable, if the available sensor devices provide only the minimum required input parameters, or if the available sensors or other information about the user are not significantly different from the average reviewing user.

As shown, the requirements section 936 indicates that one of the required parameters, energy expenditure, is not available from any of the user's devices. As such, in addition to an upgrade hardware button 938 that may point to a similar offering as the upgrade hardware button 918, an add service button 944 may point to one or more offerings for services that can provide the missing input parameter. For example, the add service button 944 may point to the first offering 910, which will provide the missing input parameter. As another alternative, these two services might be dynamically packaged together as a single offering when the service broker framework has identified the missing input parameter. Where the missing input parameter cannot be provided by a new service based on the available sensor devices for the user, the add service button 944 may be replaced with an order new hardware button (not shown) for linking the user to an offering for purchasing a new hardware device (and, potentially, additional services for use with the new hardware device). A price field 946 indicates that, upon accepting the offering via the add button 948, the user may be billed monthly for $9.99 until the service is stopped. In some embodiments, the user may be prevented from selecting the add button 948 or otherwise accepting the offering 930 until all the required inputs are available.

FIG. 10 illustrates an example of a method 1000 for generating offering recommendations. The method 1000 may be performed by a service broker framework and may be defined by offering marketplace instructions 314. This method 1000 may be executed to create a list of offerings in response to a user selection of the recommendations button 906 of interface 900.

The method begins in step 1005 and proceeds to step 1010, where the service broker framework retrieves a user profile for the current user, and then to step 1015, where the service broker framework retrieves current (or recent or historical) parameter values available from the sensor devices identified in the user profile.

The service broker framework then begins to iterate through a group of predictive models previously trained for predicting whether a user would be interested in a particular service, offering, or class of services or offerings (e.g., fitness offerings, heart health offerings, social services, etc.). For example, according to some embodiments, these predictive models include models trained according to a logistic regression approach (an example of which will be described in greater detail below with respect to FIG. 11) based on a training set that is obtained and, in some embodiments, continuously updated based on user actions such as viewing, accepting, or rating offerings. In step 1020, the service broker framework retrieves a predictive model (e.g., learned coefficients, a feature list, etc.) associated with a particular offering or class of offerings (or service or class of services) for evaluation. Next, in step 1025, the service broker framework applies the predictive model to the information gathered in steps 1010, 1015 that are features used by the predictive model and receives a relevance score from the model. For example, in some embodiments, such as those wherein the predictive model is implemented as a sigmoid function, the relevance score may be a value between 0 and 1, with higher values corresponding to higher degrees of relevance. In step 1030, the service broker framework adds the offering or class associated with the current model to an ordered list at a position corresponding to the relevance score.

Next in step 1035, the service broker framework determines whether the current predictive model is the last model to be analyzed. If not, the method 1000 loops back to step 1020 to evaluate the next predictive model. Various methods for determining whether the current model is the last model to be evaluated may be used. For example, the service broker framework may iterate through all known models, may evaluate a predetermined number of models (e.g., picking each model at random in step 1020), may evaluate a subset of models (e.g., if the user is currently browsing a particular category of offerings already), or may continue evaluating models until a predetermined number of offerings or classes are found with relevances above a threshold. Thus, it will be seen that through successive iterations of steps 1020-1035, an ordered list is built with higher relevance offerings or classes of offerings (or services or classes of services) being grouped together at the top of the list. It will be appreciated that, in various alternative embodiments, approaches other that the list building method described herein may be employed.

In step 1040, the service broker framework removes the top offering or class from the ordered list for evaluation. In step 1045, the service broker framework determines whether there is any previous indication or other configuration that this offering or class should be ignored for this user. For example, such an ignore indication may be set by the user manually indicating that they are not interested in the offering or class, automatically set by the system if the offering or class has been previously presented to the user a number of times, if the user's available sensor devices are unable to provide required inputs for the services in the offering (or are missing more than a predetermined number of inputs), or if the user already has the services (or services that are similar thereto) in the offering or class. If the offering or class is not to be ignored, the service broker framework adds the offering or class to a presentation list in step 1050. Where an offering class is to be added to the presentation list, the service broker framework may add individual offerings within the class to the presentation list (e.g., by adding all offerings in the class or by selecting a subset individual offerings within the class by random selection, through application of predictive models associated with the individual offerings to gauge relevance, or by selecting the highest rated offerings). Where a service is to be added to the presentation list, the service broker framework may search for one or more offerings associated with the service for addition to the presentation list. Where a service class is to be added, the service broker framework may first select one or more services within the service class (e.g. according to methods similar to that described above with respect to offering classes) and subsequently locate offerings associated with the selected services.

In step 1055, the service broker framework determines if the presentation list is currently full. For example, in various embodiments, the presentation list may be considered full when the number of offerings meets or exceeds a predetermined threshold (e.g., the number of offerings that may be displayed on a single screen). If the presentation list is not full, the service broker framework determines in step 1060 whether the ordered list is empty. If not, the method 1000 loops back to step 1040 where the next item is removed from the ordered list for evaluation. Once either the presentation list is full or the ordered list is exhausted, the offerings in the presentation list are presented to the user in step 1065, for example, on an interface similar to interface 900. The method 900 then proceeds to end in step 1070.

FIG. 11 illustrates an example of a method 1100 for training a predictive model. The method 1100 may correspond to instructions stored and executed by a service broker framework or another device for training prediction models that are subsequently delivered to the service broker framework for application. Various alternative approaches to model training will be apparent such as, for example, programmer-defined algorithms, neural networks, Bayesian networks, etc.

The method begins in step 1102 and proceeds to step 1104 where the device obtains a labeled data set for a given parameter for which a model is to be created. Various alternative approaches for training a model from an unlabeled training set will be apparent. In various embodiments, the training set may include a number of records of training examples that specify one or more features (e.g., user demographics, available sensor devices, retrieved parameters, etc.) and the appropriate conclusion to be drawn from that feature set. In various embodiments, the training set may be created from real-world data gathering activities such as data gathered during various users' interactions with the service broker framework. For example, each time a user views, accepts, or positively rates an offering (or service associated therewith), that user's current feature set may be captured as a training example in association with a label indicating that the offering is relevant to the user (such as a 1 or a normalized rating provided by the user). Conversely, each time a user is displayed but does not accept an offer, manually sets an ignore indication for the offering, or negatively rates an offering, that user's current feature set may be captured as a training example in association with a label indicating that the offering is not relevant to the user (such as a 0 or a normalized rating provided by the user). Various additional methods for constructing training sets for various predictive models for predicting relevance of an offering (or class of offerings) will be apparent.

In step 1106, the device identifies the number of features identified in the data set and, in step 1108, initializes a set of coefficients to be used in the resulting model. According to various embodiments, a coefficient is created for each feature along with one additional coefficient to serve as a constant. Where the model is being trained to output a numerical value, a linear regression approach may be utilized, wherein the final model function may take the form of

h(X)=θ₀+θ₁x₁+θ₂x₂

where X is the set of features {x₁, x₂, . . . } and the coefficients {θ₀, θ₁, θ₂, . . . } are to be tuned by the method 1100 to provide as output an appropriate relevance estimation, consistent with the trends learned from the training data set. In some embodiments the final model function may incorporate a sigmoid function as follows:

$$h ( X ) = \frac{1}{( 1 + {e}^{- h ( {θ}_{0} + {θ}_{1} {x}_{1} + {θ}_{2} {x}_{2} … )} )}$$

where tuning of the coefficients results in the function h(X) outputting a value between 0 and 1 that serves as an estimation of the relevance of an offering. According to various embodiments, the coefficients are all initialized to values of zero. It will be apparent that in some embodiments, additional features for inclusion in h(X) (and associated coefficients) may be constructed from the features in the training set such as, for example, x₁² or x₁x₂.

The method begins to train the coefficients by initializing two loop variables, i and p, to 0 in steps 1110, 1112 respectively. Then, in step 1114, the device obtains a partial derivative of the cost function, J(θ), on the current coefficient, θₚ, where the cost function may be defined in some embodiments as

$$J ( θ ) = \frac{1}{2} ( {\sum }_{j = 1}^{m} {( {h}_{θ} ( {x}^{( j )} ) - {y}^{( i )} )}^{2}$$

where m is the number of training examples in the training data set, h_{θ}(x) is the trained function using the current coefficient set θ, x^{(j)} is the set of features for the j^{th} training example, and y^{(j)} is the desired output (i.e., the label) for the j^{th} training example. Thus, following a batch gradient descent approach, the partial derivative on coefficient p (θₚ) may be

$${\sum }_{j = 1}^{m} ( {y}^{( i )} - {h}_{θ} ( {x}^{( j )} ) ) {x}_{p}^{( j )}$$

where xₚ^{(j)} is the p^{th} feature in the j^{th} training example (or when p=0, xₚ^{(j)}=1).

In step 1116, the device increments p and, in step 1118, the device determines whether all coefficients have been addressed in the current loop by determining whether p now exceeds the total number of features to be included in h(X). If not, the method loops back around to step 1114 to find the next partial derivative term.

After all partial derivatives are found for the current iteration, the method 1100 proceeds to reset the loop variable p to zero in step 1120. Then, in step 1122, the device updates the p^{th} coefficient, θₚ, based on the corresponding partial derivative found in step 1114 and based on a preset learning rate. For example, the device may apply the following update rule:

$${θ}_{p} = {θ}_{p} + α * {\sum }_{j = 1}^{m} ( {y}^{( i )} - {h}_{θ} ( {x}^{( j )} ) ) {x}_{p}^{( j )}$$

where α is a learning rate such as, for example, 0.1, 0.3, 1 or any other value appropriately selected for the desired rate of change on each iteration.

In step 1124, the device increments p and, in step 1126, the device determines whether all coefficients have been addressed in the current loop by determining whether p now exceeds the total number of features to be included in h(X). If not, the method loops back around to step 1122 to update the next coefficient. Note that according to the method 1100, all partial derivatives are found in a first loop prior to actually modifying the coefficients in a second loop so that the partial derivatives are not taken based on the partially updated values. Other embodiments may not implement such a “simultaneous” update of the coefficients.

After all coefficients are updated, the method proceeds to step 1128 where the variable i is incremented. In step 1130, the device determines whether i now exceeds a predefined maximum number of iterations to ensure that the method 1100 does not loop indefinitely. A sufficiently high maximum number of iterations may be chosen such as 1000, 5000, 100000, etc. If the maximum iterations has not been reached, the method 1100 proceeds to step 1132 where the device computes the current cost, using the cost function J(θ), based on the training set. In step 1134, the device determines whether the function h(X) has converged to an acceptable solution by determining whether the change in the cost from the last iteration to the present iteration fails to meet a minimum threshold. If the change surpassed the threshold the method loops back to step 1112 to perform another coefficient update loop. If, on the other hand, the maximum iterations is reached or the cost change is below the minimum threshold, the method 1100 proceeds to step 1136, where the device stores the coefficients as part of the new model for extracting the parameter and the method 1100 proceeds to end in step 1138.

It will be apparent that, in addition to following approaches other than regression, other embodiments may utilize different methods for tuning coefficients in a regression approach other than batch gradient descent. For example, some embodiments may use stochastic gradient descent, wherein each coefficient update is performed based on a single training example (thereby removing the summation from the partial derivative), and the method additionally iterates through each such example. In other embodiments, the normal equations for regression may be used to find appropriate coefficients, using a matrix-based, non-iterative approach where the set of coefficients is computed as

θ=(X^{T}X)⁻¹X^{T}y

where X is a matrix of features from all training examples and y is the associated vector of labels.

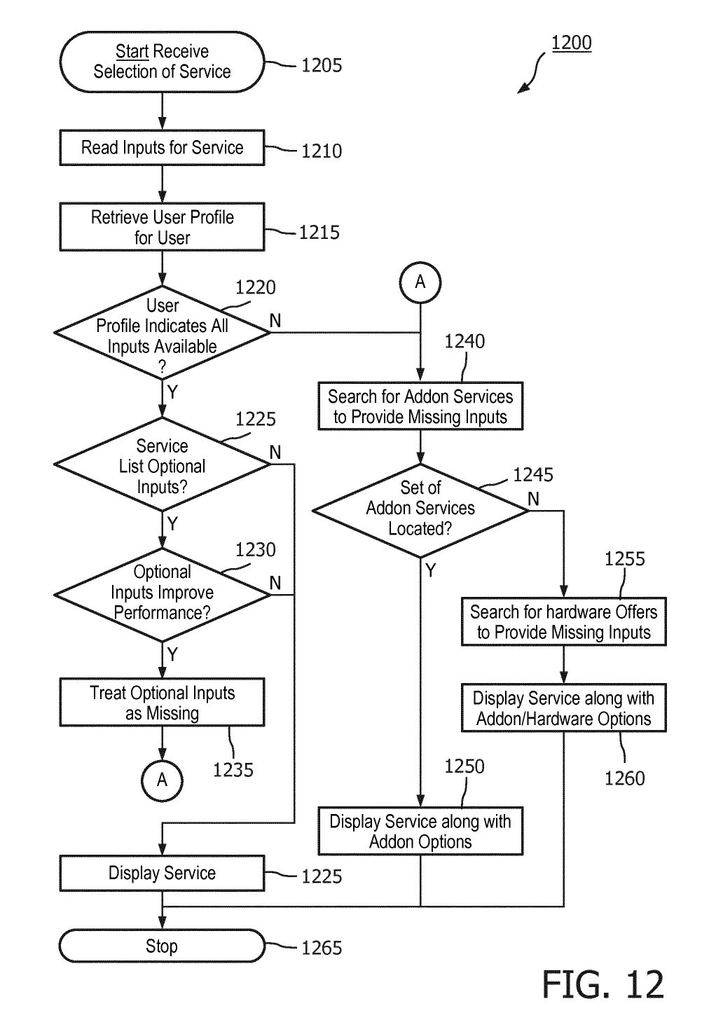

FIG. 12 illustrates an example of a method 1200 for displaying service details. The method 1200 may be performed by a service broker framework and may for example, correspond to the offering marketplace instructions 314. The method 1200 may be executed in response to user selection of a service (or offering including a service) for display. As will be explained, the method 1200 locates additional offerings for suggestion along with a displayed service or offering. Similar steps may be taken, for example, for generating the various additional offering buttons 918, 924, 938, 944 of interface 900 when offers are displayed as part of a list.

The method 1200 begins in step 1205 where the service broker framework receives a selection of a service or offering to display, and proceeds to step 1210 where the service broker framework reads the input parameters used by the service (or by the services belonging to a selected offering). In step 1215, the service broker framework retrieves the user profile for the user to determine which input parameter types are available for the user. In step 1220, the service broker framework determines whether the user profile indicates that all the inputs for the service(s) are available for the user by, for example, determine whether any of the inputs from step 1210 are not listed in the user profile. If at least one input is missing, the method 1200 proceeds to step 1240 where the service broker framework attempts to search for a service (or combination of services) that would provide the missing input based on the input parameters that are currently available.

Various methods for identifying one or more such combinations of additional services will be apparent. For example, according to some embodiments, the service broker framework may build a linked node data structure (e.g., a node graph) wherein each node is a set of input parameters, with the root node being the currently available input parameters, the end node being the currently available input parameters plus the missing input parameters, and all other nodes being an intermediate combination between the two nodes. The edges on the tree between the nodes are each associated with one of the offerings or services, originate from each node that has sufficient inputs for the associated offering or service, and terminate at each node describing the resulting input parameter set if the service is adopted. Various weights may be assigned to each such edge such as, for example, a constant 1 to minimize the number of new services to be adopted, the price of each service to minimize the cost to the user, the review rating for each service to encourage selection of. After constructing the data structure (if a connected graph can indeed be made from the available offerings), a shortest path algorithm such as Dijkstra's algorithm or the Bellman-Ford algorithm may be applied to locate the lowest cost set of edges (that is, the set of services or offerings) that will provide the necessary inputs for the service being displayed.

If in step 1245, it is determined that such a set of offerings or services exists, the method 1200 proceeds to step 1250 along where the service broker framework displays the service along with the located set of services (or multiple sets of services to be chosen from) is displayed to the user. If, on the other hand, no set of available services is found to provide all of the missing inputs, the method 1200 proceeds to step 1255 where the service broker framework locates a set of new hardware offerings, potentially along with new service offerings, that will provide the missing input parameters. For example, in some embodiments, step 1255 may follow a similar approach as described above with respect to step 1240, except edges may be defined by both hardware and service offerings. In some embodiments, steps 1240 and 1255 may be collapsed into a single searching step. For example, a graph with both hardware and service offerings may be searched once; hardware offering edges may be given a cost penalty in some embodiments such that the service broker framework will favor returning sets of only services for providing missing inputs when available. After identifying one or more hardware offerings (and potentially one or more service offerings) for providing the missing inputs, the requested service is displayed along with these located addon options in step 1260.

If, on the other hand, it is determined in step 1220 that the user already has sufficient hardware and services to meet the requirements for the service to be displayed, the service broker framework then determines in step 1225 whether the service is associated with any optional input parameters and, if so, determines in step 1230 whether the optional input parameters improve performance or satisfaction with the service (e.g., by comparing user ratings, reviews, usage statistics, etc. from users providing the optional parameters versus users missing the optional parameters). If there are indeed optional parameters that improve performance, the method 1200 proceeds to step 1235 where the optional inputs are marked as “missing” for the purposes of the following steps, and the method 1200 proceeds to step 1240. If, on the other hand, there are no optional parameters or the optional parameters do not appreciably improve the service, the service broker framework simply displays the service in step 1225 without any service recommendations. The method 1200 then proceeds to end in step 1265.

It will be appreciated that method 1200 is just one example and that various other methods for determining how to display a selected service or how to identify options for recommending complementary offerings may be employed. For example, in some embodiments, the method may always recommend at least one set of addon offerings even if they are not required and are not expected to improve performance. As another alternative, some offerings may be classified as featured and, as such, always presented or presented whenever sufficiently relevant to the displayed service or offering.

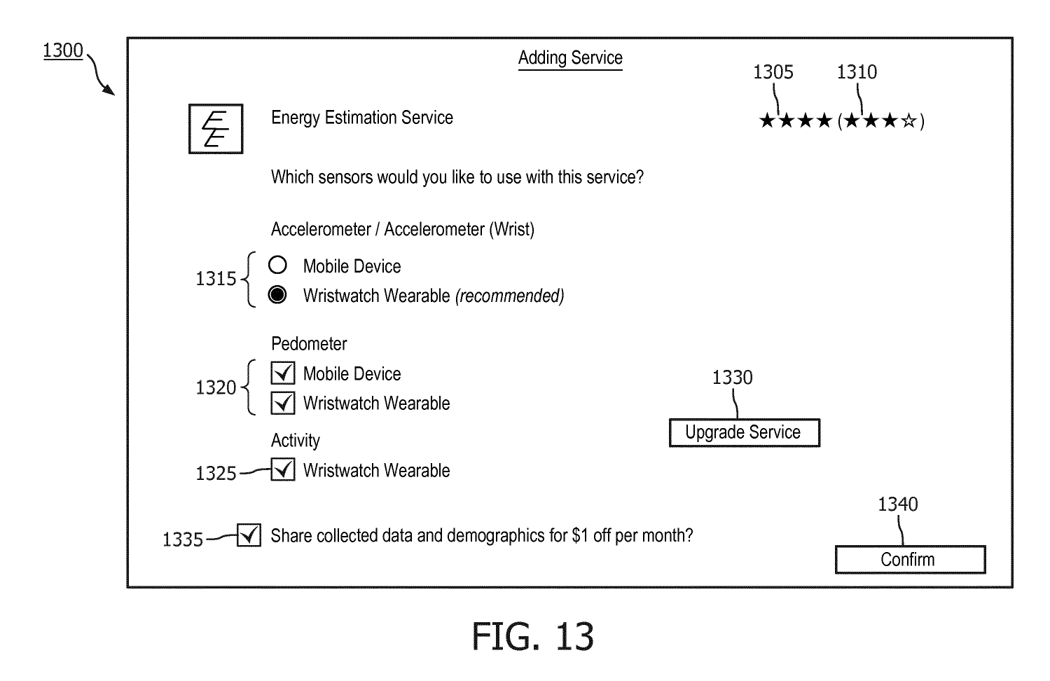

FIG. 13 illustrates an example of an interface 1300 for adding a new service for a user. The interface 1300 may be displayed on a device of the consumer (e.g., a mobile phone, tablet, pc, or wearable device) and may be generated by the marketplace instructions 314. In various embodiments, the interface 1300 may be displayed after selection or purchase of an offering associated with the service and may be used to configure the operation of the service going forward.

As shown, the interface 1300 again includes the personalized rating 1305 and generic rating 1310, similar to those 912, 914 displayed on the interface 900 for browsing offerings. As shown, the user is presented with multiple options 1315, 1320, 1325 for determining which sensor devices will provide input parameters to the new service. For example, an accelerometer selection 1315 allows the user to select either their mobile device or wristwatch wearable (or, alternatively, “MobilePhone123” and “Wristwatch-5D3”) to provide accelerometer data. The service broker framework indicates that the wristwatch wearable is recommended for selection (e.g., based on comparing performance of the service or ratings from users when either of these devices are selected). Similarly, a pedometer selection 1320 allows the user to select their mobile device, wristwatch wearable, or both for providing pedometer data to the service. This selection 1320 may be in the form of checkboxes instead of radio buttons to enable selection of both devices. This may be desirable, for example, when the service is adapted to make use of multiple pedometer sources, but only accepts accelerometer data from one source at a time. In the case where the pedometer input parameter is required, the interface 1300 may disallow deselection of both checkboxes in the selection 1320. An activity selection 1325 enables the user to indicate whether an activity parameter (an optional input parameter for the service) should be shared from the wristwatch wearable device.

An upgrade service button 1330 may be similar to the upgrade buttons 918, 924, 938, 944 of interface 900 in that it may present a service for estimating an activity parameter that will improve performance of the service once configured. In various embodiments, addition of such other services and modification of the selection elements 1315, 1320, 1325 may update the personalized rating 1305 as the prospective inputs are changed (e.g., by selecting different “similar user” groups to take those reviews into account for the personalized rating 1305). A data sharing box 1335 may be selectable to indicate that data should be shared with one or more optional third parties. In some cases, selection of the box 1335 may result in a discount or payment made to the consumer in return for their agreement to share data. The confirm button 1340 may commit the selections and trigger sensor binding to the service or saving of sharing configurations, as appropriate and based on whether the service broker framework will operate as an intermediary for the service.

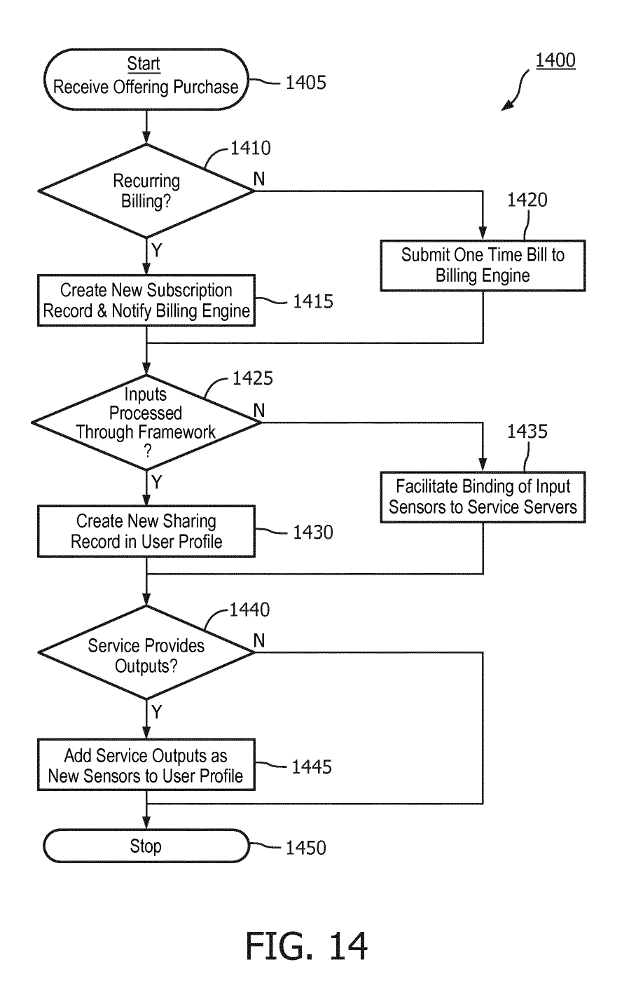

FIG. 14 illustrates an example of a method 1400 for effecting an offering purchase. The method 1300 may be performed by a service broker framework and may for example, correspond to the offering marketplace instructions 314. The method 1300 may be executed in response to user selection of a service (or offering including a service) for purchase. For example, in some embodiments, the method 1400 may be executed in response to the user selecting the confirm button 1340 of the interface 1300.

The method 1400 begins in step 1405 and proceeds to step 1410 where the service broker framework determines whether the offering requires recurring billing or a one-time purchase. If there will be recurring billing, the method 1400 proceeds to step 1410 where the service broker framework creates a subscription record identifying the user, billing amount, and billing period and notifies the billing engine that the initial payment should be processed. Otherwise, the service broker framework simply submits the bill for processing by the billing engine in step 1420.

In step 1425, the service broker framework determines whether the inputs to the new service(s) are to be processed through the service broker framework as an intermediary. For example, the service broker framework may determine whether any of the selected devices (or their reporting frameworks) can be configured to provide inputs directly to the service application device or if the service has been configured for such intermediary functionality. If so, the service broker framework creates a new sharing record in the user profile in step 1430. Such sharing record may correspond, for example, to the set of sharing records 760. If, on the other hand, the service broker framework will not act as an intermediary, the service broker framework proceeds to facilitate sensor binding in 1435 by configuring the sensor devices or service application device to effect the needed transfer of input parameters.

In step 1440, the service broker framework determines whether the new service(s) provide any output parameters that may serve as input parameters to other services. For example, this information may have been specified by the service provider via the interface 500 or may be advertised by the service application device via an API of the service broker framework. If so, the service broker framework adds the service as a new sensor device providing the new input parameters to the user profile. For example, the service broker framework may add a new record to the sensor device record 740. The method 1400 then proceeds to end in step 1400.

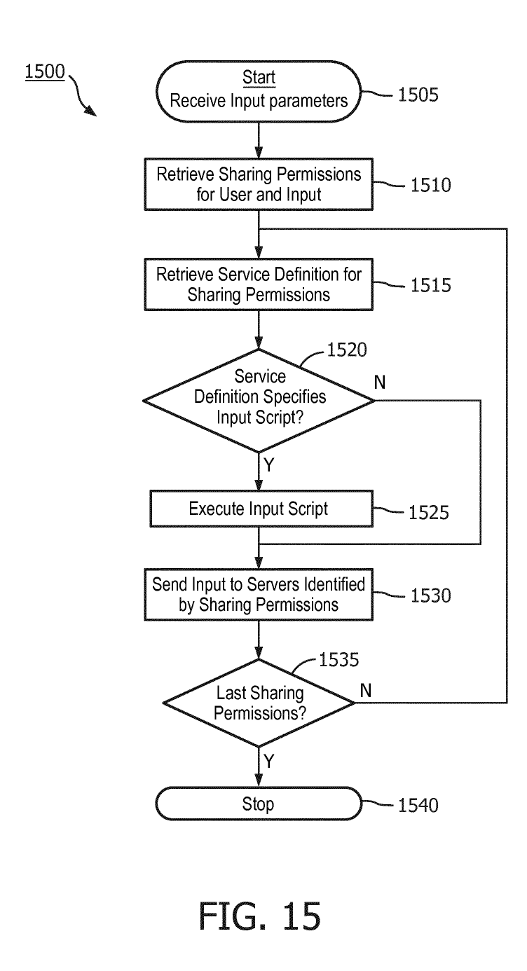

FIG. 15 illustrates an example of a method 1500 for facilitating input sharing. The method 1500 may be performed by the sensor data forwarding instructions 394. The method 1500 begins in step 1505 where the service broker framework receives input parameters from one or more sensor devices of a user. In step 1510, the service broker framework retrieves a set of sharing permissions for the user (e.g., one of the sharing configurations 760 from the user profile 700) that apply to the received input parameters. Then, in step 1515, the service broker framework retrieves the service definition for the current sharing permission record. In step 1520, the service broker framework determines whether the service record identifies an input preprocessing script and if so, executes the script in step 1525. Then, the service broker framework transmits the input to any servers identified in the sharing permissions record in step 1530. In step 1535, the service broker framework determines whether additional service permissions record remain to be evaluated for the input. If so, the method 1500 loops back to step 1500. Once all sharing permissions records have been processed, the method proceeds to end in step 1540.

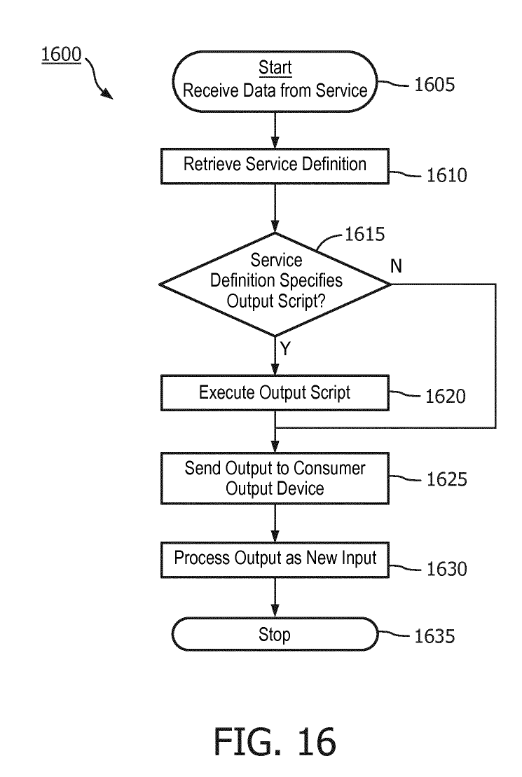

FIG. 16 illustrates an example of a method 1600 for facilitating output presentation. The method 1600 may be performed by the service presentation instructions 396. The method 1600 begins in step 1605 where the service broker framework receives data from a service application device. The service broker framework then retrieves the service record for the service in step 1610 and determines, in step 1615, whether the service has defined any output processing scripts. If so, the service broker framework executes the script in step 1620. The service broker framework then sends the output to the consumer output device(s) in step 1625 and processes and output parameters as new input parameters in step 1630. For example, the service broker framework may invoke the input processing method 1500 to process these newly received parameters. The method 1600 may then proceed to end in step 1635.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A service broker device comprising:
a communications interface;
a memory storing:
a user profile associated with a user and specifying an available input type available from a sensor device of the user, wherein the input type is a physiological parameter of the user, and
a plurality of service records, wherein a first service record of the plurality of service records is associated with a service, an input type, an output type of the service, and a server that provides the service, wherein the output type is another physiological parameter; and
a processor in communication with the communications interface and the memory, the processor being configured to:
receive, from the user via the communications interface, a request to add, for the user, the service associated with the first service record of the plurality of service records, wherein the service record indicates that the available input type specified by the user profile is accepted by the server as an input for providing the service,
effect transmission of data gathered by the sensor device of the user and of the input type identified by the service record to the server associated with the service record, and
add the service to the user profiles as an additional sensor device that provides an additional input type, wherein the additional input type is the output type identified by the service record.

2. The service broker device of claim 1 wherein, in effecting transmission of data gathered by the sensor device of the user and of the input type identified by the service record to the server identified by the service record, the processor is configured to:
transmit configuration information to an input device, wherein the input device is at least one of the sensor device of the user and a reporting framework device that receives the data from the sensor device;
wherein the configuration information configures the input device to transmit the data directly to the server identified by the service record.

3. The service broker device of claim 1 wherein, in effecting transmission of data gathered by the sensor device of the user and of the input type identified by the service record to the server identified by the service record, the processor is configured to:
transmit credentials information to the server identified by the service record, wherein the credentials information enables the server to request the data from at least one of the sensor device of the user and a reporting framework device associated with the sensor device.

4. The service broker device of claim 1 wherein, in effecting transmission of data gathered by the sensor device of the user and of the input type identified by the service record to the server identified by the service record, the processor is configured to:
record an indication in association with the user that the data is to be forwarded to the server identified by the service record;
receive the data from at least one of the sensor device of the user and a reporting framework device associated with the sensor device;
based on the recorded indication, transmit the received data to the server.

5. The service broker device of claim 4, wherein:
the service record is associated with an input processing action to be performed prior to transmission; and
the processor is further configured to, prior to transmitting the received data to the server, modify the data according to the input processing action.

6. (canceled)

7. The service broker device of claim 1, wherein the processor is further configured to effect billing of at least one of the user and a provider of the service in response to the request to add the service.

8. The service broker device of claim 1, wherein the processor is further configured to:
identify a set of available services for the user based on the respective input types of the available services being available from the user as indicated by the user profile; and
present the set of available services to the user for selection of individual services to add for the user.

9. The service broker device of claim 1, wherein the processor is further configured to:
receive a selection of a first additional service from the user, wherein the first additional service is associated with an additional service record of the plurality of service records;
determine that an additional input type identified by the additional service record is not identified as available from the user based on the user profile; and
presenting at least one offering to the user that would provide the additional input type.

10. The service broker device of claim 1, wherein the offering comprises a second additional service that provides the additional input type as an output.

11. A method performed by a processor of a service broker device for expanding services provided via wearable devices, the method comprising:
receiving, from a user, an identification of an available input type available from a sensor device of the user, wherein the input type is a physiological parameter of the user;
receiving, from the user, a request to add a service, wherein the service is known to accept the available input type as an input and provides output having an output type, wherein the output type is another physiological parameter;
effecting transmission of data gathered by the sensor device of the user and of the available input type to a server that provides the service, and
add the service to a user profile as an additional sensor device that provides an additional input type for use by other services, wherein the additional input type is the output type.

12. The method of claim 11 wherein the step of effecting transmission of data gathered by the sensor device of the user and of the input type identified by the service record to the server identified by the service record comprises:
transmitting configuration information an input device, wherein the input device is at least one of the sensor device of the user and a reporting framework device that receives the data from the sensor device;
wherein the configuration information configures the input device to transmit the data directly to the server identified by the service record.

13. The method of claim 11 wherein the step of effecting transmission of data gathered by the sensor device of the user and of the input type identified by the service record to the server identified by the service record comprises:
transmitting credentials information to the server identified by the service record, wherein the credentials information enables the server to request the data from at least one of the sensor device of the user and a reporting framework device associated with the sensor device.

14. The method of claim 11 wherein the step of effecting transmission of data gathered by the sensor device of the user and of the input type identified by the service record to the server identified by the service record comprises:
recording an indication in association with the user that the data is to be forwarded to the server identified by the service record;
receiving the data from at least one of the sensor device of the user and a reporting framework device associated with the sensor device;
based on the recorded indication, transmitting the received data to the server.

15. (canceled)
